(19) United States
(12) Patent Application Publication
(10) Pub. No.: US 2022/0278853 A1
(43) Pub. Date: Sep. 1, 2022

(54) DECENTRALIZED PROTOCOL FOR MAINTAINING CRYPTOGRAPHICALLY PROVEN MULTI-PARTY-STATE-CHAINS UTILIZING AGGREGATED SIGNATURES

(71) Applicant: 2KEY NEW ECONOMICS LTD., Tel Aviv (IL)

(72) Inventors: Ehud BEN-REUVEN, Tel Aviv (IL); EiTan LAVI, Tel Aviv (IL)

(21) Appl. No.: 17/631,879

(22) PCT Filed: Jul. 29, 2020
(86) PCT No.: PCT/US2020/044121

§ 371 Date: Jan. 31, 2022

Related U.S. Application Data
(60) Provisional application No. 62/879,592, filed on Jul. 29, 2019.

(51) Int. Cl. H04L 9/32; H04L 9/14; H04L 9/08

(52) U.S. Cl. CPC H04L 9/3252; H04L 9/14; H04L 9/0825; H04L 9/085

(57) ABSTRACT

Systems and methods are disclosed for a decentralized protocol for maintaining cryptographically proven multi-party state chains utilizing aggregated signatures. In one implementation, a first link is received, the first link including a first private key generated with respect to a first user. A second private key is generated with respect to a second user. Using the second private key, a cryptographic signature of the first private key is computed. A second link is generated, the second link including the second private key, the cryptographic signature of the first private key, and one or more public keys.

### CROSS-REFERENCE TO RELATED APPLICATIONS

This application is related to and claims the benefit of priority to U.S. Patent Application No. 62/879,592, filed Jul. 29, 2019, which is incorporated herein by reference in its entirety. This application is also related to International Application No. PCT/US2019/028212, filed Apr. 18, 2019, which is incorporated herein by reference in its entirety.

### TECHNICAL FIELD

Aspects and implementations of the present disclosure relate to data processing and, more specifically, but without limitation, to a decentralized protocol for maintaining cryptographically proven multi-step referral networks utilizing aggregated signatures.

### BACKGROUND

Tracking codes can be used across the Internet for marketing-attributions and conversion tracking. Such codes require complex integrations and ongoing management by site/app owners and influencers.

Data/records can be stored on a decentralized or distributed ledger such as blockchain that is synchronized across multiple computing/storage devices. Various cryptographic techniques can be utilized to secure such records.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system, in accordance with an example embodiment

FIG. 2A illustrates an example system, in accordance with an example embodiment.

FIG. 2B illustrates an example system, in accordance with an example embodiment.

FIG. 3 is a flow chart illustrating aspects of a method for implementing a decentralized protocol for maintaining cryptographically proven multi-step referral networks, in accordance with an example embodiment.

FIG. 4 is a flow chart illustrating aspects of a method for implementing a decentralized protocol for maintaining cryptographically proven multi-step referral networks, in accordance with an example embodiment.

FIGS. 5A-5C are flow charts illustrating aspects of a method for implementing a decentralized protocol for maintaining cryptographically proven multi-step referral networks, in accordance with an example embodiment.

FIGS. 6A-6C are flow charts illustrating aspects of a method for implementing a decentralized protocol for maintaining cryptographically proven multi-step referral networks, in accordance with an example embodiment.

FIGS. 7A-7C are flow charts illustrating aspects of a method for implementing a decentralized protocol for maintaining cryptographically proven multi-step referral networks, in accordance with an example embodiment.

FIG. 8 is a block diagram illustrating components of a machine able to read instructions from a machine-readable medium and perform any of the methodologies discussed herein, according to an example embodiment.

### DETAILED DESCRIPTION

Aspects and implementations of the present disclosure are directed to a decentralized protocol for maintaining cryptographically proven multi-step referral networks utilizing aggregated signatures.

Existing referral-tracking technologies rely on tracking codes for marketing-attributions and conversion tracking. Such codes require complex integrations and ongoing management by site/app owners and influencers that are tasked in propagating the products being sold. Additionally, such codes often require no visibility outside the websites/apps in which they're installed and therefore cannot be placed on a public service such as a blockchain. Additionally, information that is tracked using such codes by separate competing website/app owners will be segregated (such that information tracked by one service may be unavailable to another service). As a result, the influencers are required to do some integration work in advance with the owner. For example, the owner and each influencer can agree on a separate code. In addition, one influencer cannot pass the code to another influencer and give him some of the credit for any referral made.

Accordingly, described herein in various implementations are technologies that enable referral tracking and other related technologies that don't require the web site to hold a secret code. As described in detail herein, the disclosed technologies can migrate the Internet's tracking from siloed code integrations within business websites or apps into the tracking links themselves.

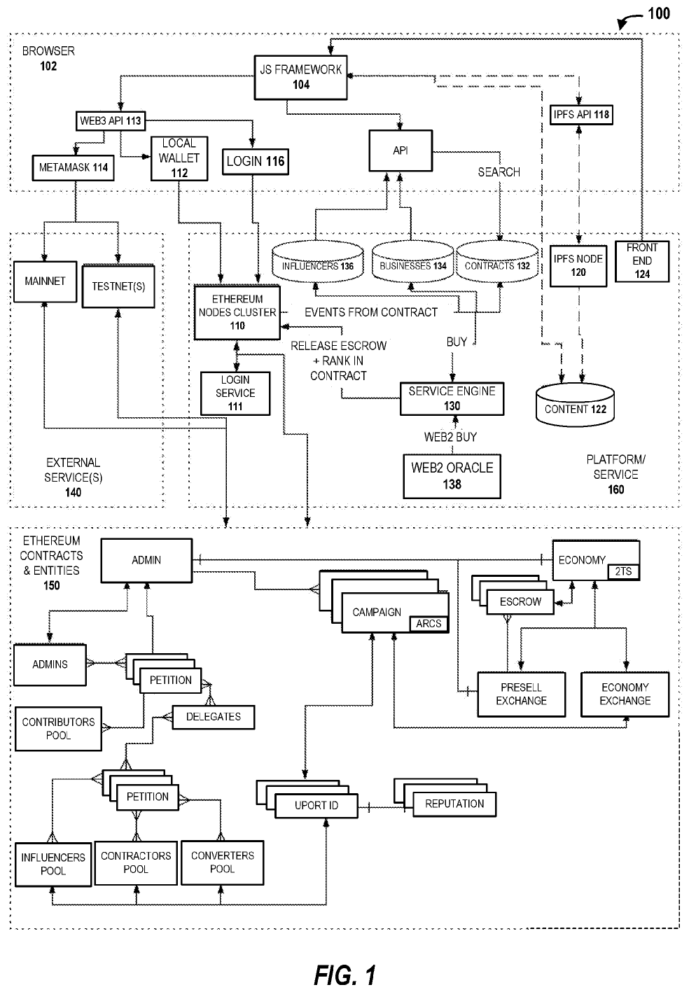

An example environment (including system 100) is depicted in FIG. 1. As shown in FIG. 1, the described technologies (including systems, methods, services, platforms, etc., such as those described/referenced herein) can be implemented in conjunction with various devices, components, elements, etc. For example, an example platform can include or otherwise interface with a decentralized or distributed ledger such as a blockchain (e.g., Ethereum 150, as shown in FIG. 1) that can be distributed/stored across multiple connected nodes. Examples of such nodes are depicted in FIG. 1 and described herein.

The referenced nodes can be computing devices, storage device, and/or any other such connected device or component configured to generate and/or provide verification (e.g., for a transaction, operation, etc.). Various nodes can be connected to one another (directly or indirectly) via various network connections, thereby forming a distributed computing environment or network.

In an example transaction, ownership of a digital token can be transferred from one address to another. To authenticate the transaction, the transaction recording the transfer can be signed by the originating party using a private key associated with that originating party (e.g., as stored on a device or wallet, such as “wallet” as shown in FIG. 1). Such a private key can be a cryptographic key (e.g., a string of bits used by a cryptographic algorithm to transform plain text into cipher text or vice versa) that may be kept secret by a party and used to sign transactions (e.g., the transfer of a token to another user, to a server, etc.) such that they may be verified using the described distributed computing environment.

The referenced signed transaction can then be broadcast across the distributed computing environment/network, where it can be verified, e.g., using the public key associated with the originating party. Such a “public key” can be a cryptographic key that is distributed to, or available to the referenced node(s) so that signed transactions associated with the public key may be verified by the nodes.

During the referenced verification process, the transaction can be accessed or selected by a consensus node (e.g., a device or ‘miner’ configured to verify transactions and add new blocks to a blockchain), verified using the public key, timestamped, and added to a “block” that includes other transaction(s). To perform the referenced verification the consensus node can, for example, solve a cryptographic puzzle, e.g., to identify a nonce value that, when used with a hash function, results in a value formatted in a specific way. Upon solving the puzzle, the consensus node creates a proof of work that is then verified and (if the solution is valid) added to the blockchain ledger.

Adding completed blocks to the blockchain ledger forms a permanent public record of various included transactions. The blockchain ledger can be replicated and distributed across multiple nodes within the distributed environment. In the event that a user tries to utilize a previously transferred digital token, the first transaction conducted using the token address may promulgate to remote nodes faster than any subsequently conducted transaction using the same token address. This allows more time for additional blocks to be added to the blockchain that include the first transaction. In this scenario, a node that receives two separate chains that include blocks with transactions originating from the same token address will choose the longest chain, which should be associated with the first conducted transaction. In such a manner, the blockchain may be used to provide verification of various operations, transactions, etc.

In most blockchain solutions all the information stored can be accessed anonymously by anyone and by itself it cannot store secrets.

Further aspects of the technologies depicted in FIG. 1 are described in detail below.

It can be appreciated that users, entities, businesses, etc. (which may be referred to herein as “contractors”) want other users, entities, or businesses, e.g., customers (which may be referred to herein as “converters”) to purchase, acquire, etc., a unit of its product (which may be referred to herein as “converting”). Using existing technologies, the business can provide a link (e.g., a hyperlink or URL) to a customer through which supplies content that describes the product and provides an option for the customer to buy a unit (“convert”). In certain implementations, the technologies described herein enable such a link to be provided to as many potential customers as possible.

As described herein, in certain implementations the referenced purchase (or related transaction(s)) can be performed using blockchain smart contracts. The business creates a contract on a blockchain (e.g. Ethereum) and a customer buys a unit by sending currency (Ether, coins, etc.) to the contract which then keeps track of the fact that the customer has bought a unit

Existing (“Web 2.0”) technologies enable businesses to disseminate link(s) to customers in various ways. For example, users such as marketing “influencers” can disseminate a link to other users. Such a link can be assigned a unique offer code which helps compensate the influencer in some way. This technique has various limitations. For example, the business may need to initially form a relationship with an influencer. Additionally, these technologies may only be able to track/compensate a single influencer per conversion. In other words, the path of influencers between the business and the customer is of size one. Additionally, a customer may visit the business site directly without the use of the offer code. Additionally, the offer code itself has to somehow be made known to converters only by the influencer that is assigned to it, otherwise it becomes meaningless. The offer code therefore cannot be placed in a public repository accessible to anyone. However, this is usually a requirement when building a blockchain solution.

As described in detail herein, the disclosed technologies enable further solutions to the referenced problem(s)/shortcomings. In certain implementations, such technologies can utilize or implemented decentralized or distributed computing technologies such as blockchain (“Web 3.0). For example, in certain implementations a contract (that is, a ‘smart contract’) can be created for each campaign being sold. The contract can implement a digital token (which may be referred to herein as an “action referral coin” or ARC). Such a token can be used to track the path between influencers up to the conversion, as described herein. However, it requires each influencer to interact with the contract at least once, this requires some fee to be payed to the blockchain system and/or may be limited by the rate at which transactions can be processed on the blockchain.

In certain implementations, the referenced technologies can be implemented using the referenced web 3.0 technologies with cryptographic signature or ‘zero knowledge’ (zk). Such an implementation can be based on or utilize web 3.0 technologies without requiring interaction of the influencers with the blockchain. In certain implementations, such implementations can utilize or incorporate various cryptographic algorithms or techniques (including but not limited to digital signature algorithms or the ‘zkSNARKs’ cryptographic algorithm).

In one example implementation, a business creates a campaign by creating a contract on the blockchain and a link to it. The contract can be publicly available/accessible while the referenced link can contain a secret/private key (similar to an offer code) known only to those who received the link. The business can attempt to pass the link to as many potential customers as possible. These customers know the secret and can use it to obtain a permission, from the contract, to buy/acquire a unit. The business wants to reach more customers, for that it motivates influencers to modify the secret in the link and pass a new link to more customers. The contract itself, however, cannot hold any of the secrets because its entire content is available to anyone.

To keep the influencers motivated to reach customers that did not receive/view the original link, the following techniques can be utilized. The referenced private key/secret information can be passed through links but information on the blockchain (which is always public) may not contain any secret. This provides the influencers an assurance that it is impossible to remove them from a link they have modified and published without having access to the original link. Instead of the original secret, the modified link contains a cryptographic signature or zero-knowledge proof that the influencer knew the original secret. In addition, the modified link contains a modified secret which can be a cryptographic hash of the original secret or it can be a completely new secret This ensures that it is very hard to derive the original secret if you only know the modified secret. In what follows the word ‘hash’ is used to describe a cryptographic hash function.

When buying/acquiring, a customer can also generate a cryptographic signature or zero-knowledge proof that she knew the secret (otherwise it may be possible for her to remove the influencer(s)). The customer sends her proof along with the proof of the influencer(s) to be able to buy the product

The contract verifies the proofs and that the influencer(s) and the customer each knew their respective secret along the path. It can then allow the customer to buy the product and allocates a bounty for the influencer(s).

Other influencers can use the new link and modify it again by adding to the link a proof that they know what the modified secret was. In addition, they can add the secret modified yet again allowing for customers or yet more influencers to use their link.

It can be appreciated that the described technologies can be advantageous in multiple scenarios. For example, the described technologies don't necessarily require influencers to have any interaction with Ethereum until a conversion is made (and therefore no “gas”—e.g., an execution fee—is spent).

The described system/platform (e.g., as depicted in FIG. 1) can be utilized, accessed, interacted with, etc., by multiple parties, participants, users, etc. Examples of such parties include but are not limited to contractors, influencers and converters, such as are described/referenced herein. Such users can, for example, interact with an application (which can be a distributed application or ‘dApp’). In certain implementations, the referenced application can run/execute in a browser. The browser can be directed to a website (e.g., front-end 124) containing content for running the application (e.g., HTML, images, and JavaScript code). In other implementations, the referenced application can be provided as a mobile or desktop app.

In certain implementations, the referenced dApp can connect or interface with one or more Ethereum nodes 110, e.g., via an API such as a Web3 API 113, such as is shown in FIG. 1. The Ethereum nodes can form with or connected to other nodes the Ethereum network 150. In certain implementations, the Web3 API can utilize or access a wallet. Such a wallet can be, for example, a MetaMask browser plugin 114 or stored locally 112 on the browser between sessions or stored on a login service such as the Ethereum node 110 (which may require the user to utilize a login interface 116 to connect to a login service 111).

The referenced dApp can optionally connect to an InterPlanetary File System (tPFS) (or another such protocol) node 120 via an API 118. Such IPFS nodes can form a peer-to-peer network for storing content 122. The dApp can use this network to store content related to a contract. As described herein, the dApp can also use the network (e.g., IPFS) to store cryptographic signatures or zero-knowledge proofs. It should be understood that IPFS is referenced herein only by way of example, and that any other centralized or decentralized storage resource or service can also be utilized.

In certain implementations, the referenced dApp can utilize a service engine 130 (which can be, for example, an application, module, service, etc.) and/or one or more other elements within platform/service 160. Such an engine can be an application, program, module, etc. that executes on/in conjunction with platform/service 160 and tracks changes on the Ethereum network and updates repositories of contracts (132), businesses (contractors) (134) and influencers (136). The engine 130 can also rank business and influencers.

In certain implementations the referenced engine can function as an administrator, e.g., to a contract's escrow mechanism. For example, a web2.0 plugin installed at business web sites can be used (e.g., as an ‘oracle’ 138 such as is depicted in FIG. 1) to detect if a conversion was finalized. When that happens, the oracle can communicate with the relevant contract and release the purchase that was held in escrow. When releasing a purchase, the oracle can determine how to distribute the bounty between influencers (e.g., based on their rank).

It should be noted that, in certain implementations, users can use a dedicated ICO contract for their transactions (e.g., instead of Ether).

State channel system—the system described herein may involve calling the buy-method of the contract by a customer who wishes to convert. This call may require validation of zero-knowledge proof which can be ‘expensive’ when done by Ethereum. Alternatively, in certain implementations a state channel can be maintained between the contract administrator (e.g., the business or the described platform) and the user(s). In such a configuration, the customer sends a buy request to the administrator instead of the contract. The administrator can perform the ‘expensive’ validation off-chain and generates a signed confirmation that a conversion was made. Such a confirmation can be sent to other user(s) involved who can use the signed confirmation, e.g., to withdraw their balance from the contract. If multiple conversions are happening in the same contract, the confirmed conversions made can be accumulated. Doing so, allows users to withdraw their balance in a single (“cheap”) Ethereum transaction.

The validation of the proof can also be performed, for example, by one or more external service providers (‘oracles’). These service providers can be listed in the contract (e.g., when it is created). To ensure that an oracle is validating legitimate proofs, the described technologies can be configured to require that each oracle sets up a contract on Ethereum that holds a deposit made by the oracle. This oracle can release the deposit to anyone who can demonstrate that the oracle has rejected a buy transaction that should have been approved.

Web 2.0 system using zero-knowledge or other such cryptographic signature techniques—the methods, techniques, etc. described herein can be used in a web 2.0 system that does not utilize contracts (e.g., in any way). In certain implementations, the referenced state-channel system can be implemented in a web 2.0 site. The proof validation can be used to withdraw a balance from the website itself (and not from the contract). The advantage of such a system (e.g., compared to a regular web 2.0 website) is enabling more than one influencer in the path from the business to the customer. Another advantage is that the influencers don't necessarily need to sign up or register in advance with the business before publishing a link. Each influencer can be identified by her address and converting this address into something (e.g., an identifier) that can be used to withdraw a balance may only be needed when a withdraw operation is made for the first time.

In certain implementations, the described technologies can be configured such that the referenced influencer does not necessarily need to interact with the referenced website. For example, the referenced address itself can be utilized to perform the described bounty transfer. In such a scenario, the website can automatically send bounties to associated influencers based on their address. Such an address can be, for example, a valid address on any banking system (regular, online, or cryptocurrency system).

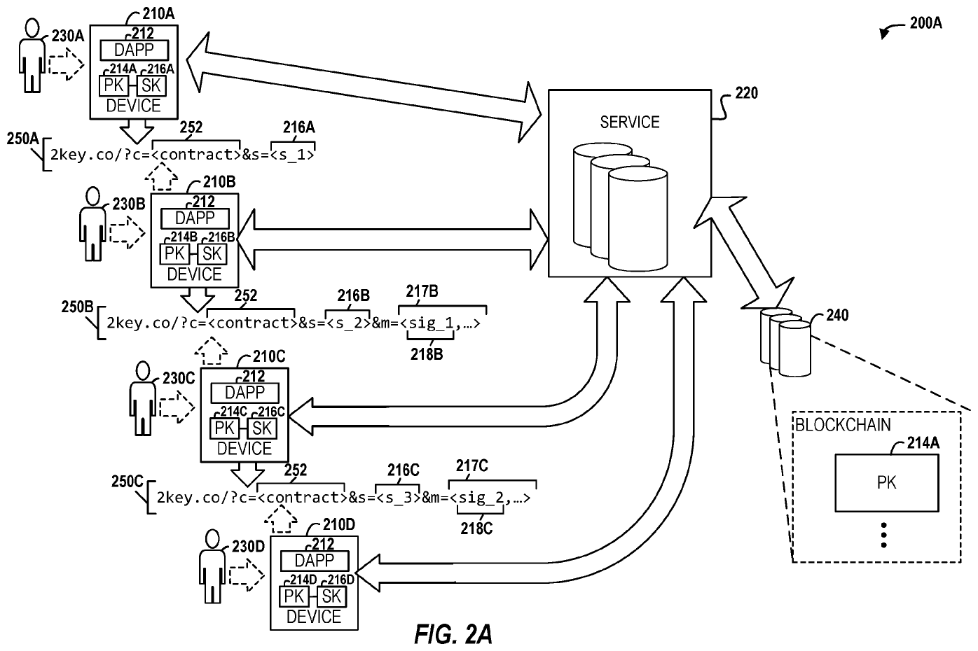

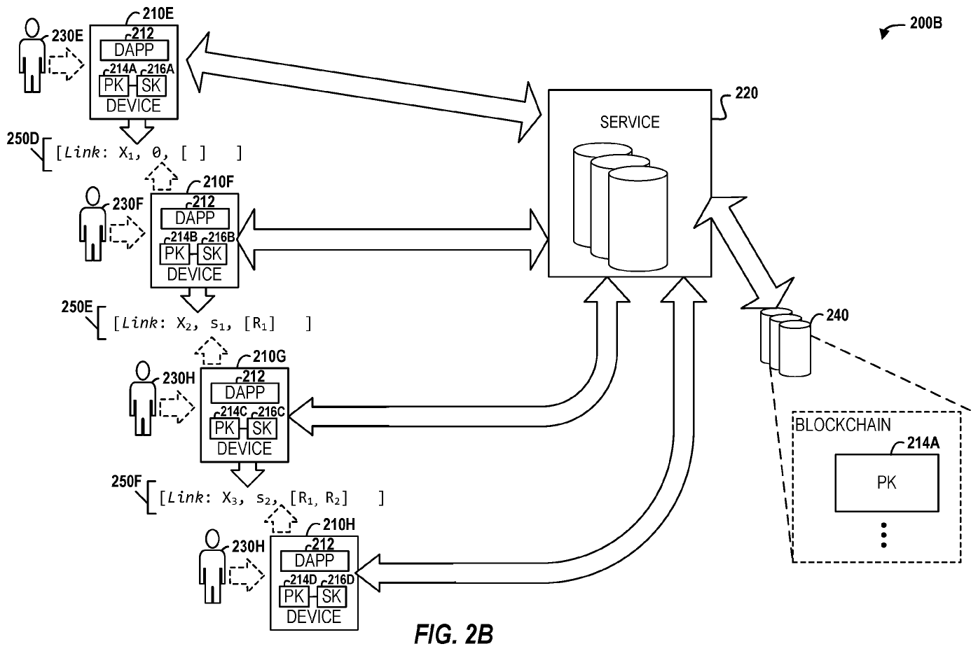

Further aspects of the described elements, operations, and lifecycle are depicted in FIGS. 2A-2B which depict aspects of example systems 200A and 200B, respectively, in accordance with some implementations. It should be understood that elements depicted with respect to such systems 200A-B are also depicted with respect to FIG. 1 and described in further detail herein.

As shown, systems 200A and 200B can each include components such as device(s) 210. Device 210 can include a laptop computer, a desktop computer, a terminal, a mobile phone, a tablet computer, a smart watch, a wearable device, a personal digital assistant (PDA), a digital music player, a connected device, a speaker device, a server, and the like. User(s) 230 can each be human users who interacts with respective device(s). For example, user 230A can provide various inputs (e.g., via an input device/interface such as a keyboard, mouse, touchscreen, microphone, camera, etc.) to device 210A. Such device(s) can also display, project, and/or otherwise provide content to the user (e.g., via output components such as a screen, speaker, etc.).

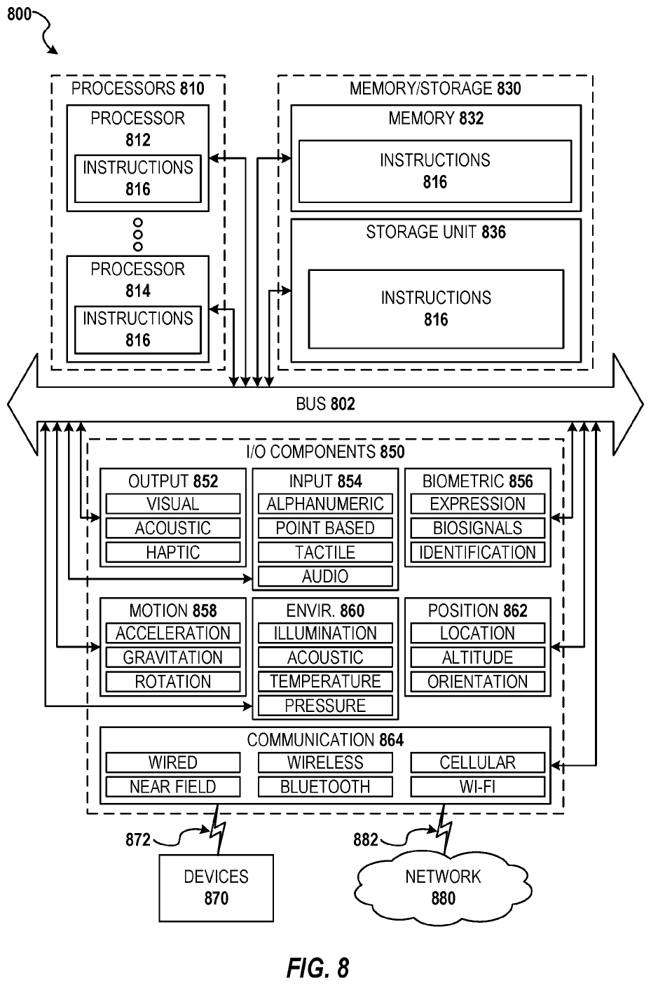

As shown in FIGS. 1-2B, such device(s) can include one or more applications such as distributed application (‘dApp’) 212. Such an application can be a program, module, or other executable instructions that configure/enable the device to interact with, provide content to, and/or otherwise perform operations on behalf of a user, e.g., in order to initiate and/or execute various operations as described in detail herein. Such application(s) can be stored in memory of one or more device(s) (e.g. memory 830 as depicted in FIG. 8 and described below). One or more processor(s) of the device (e.g., processors 810 as depicted in FIG. 8 and described below) can execute such application(s). In doing so, one or more of the referenced device(s) can be configured to perform various operations as described herein. Additionally, in certain implementations the referenced dApp can execute in conjunction with a browser executing on the referenced device, as depicted in FIG. 1 and described in detail herein.

It should be noted that while dApp 212 is depicted and/or described as operating on a device, this is only for the sake of clarity. However, in other implementations such elements can also be implemented on other devices/machines. For example, in lieu of executing locally at a device 210, aspects of the referenced application(s) can be implemented remotely (e.g., on a server device or within a cloud service or decentralized framework).

As also shown in FIGS. 2A-B, device(s) 210 can connect to and/or otherwise communicate with service 220 (e.g., a centralized, decentralized, or distributed service, such as is depicted in FIG. 1 and described in detail herein). Connections between the various devices/machines can be initiated and/or maintained via various networks such as the Internet, a wide area network (WAN), a local area network (LAN), a virtual private network (VPN), an intranet, and the like.

Further aspects of the operations of systems 200A and 200B are described in detail herein.

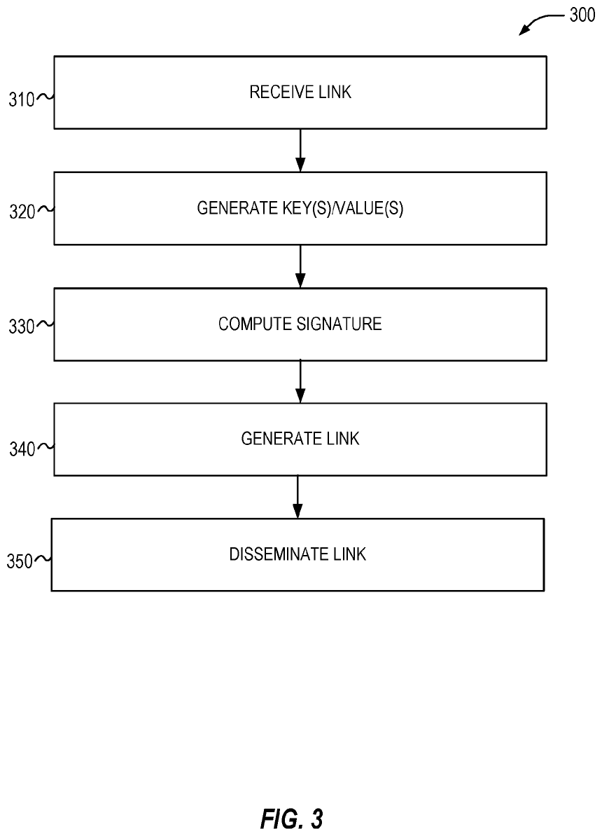

FIG. 3 is a flow chart illustrating a method 300, according to an example embodiment, for implementing a decentralized protocol for maintaining cryptographically proven multi-step referral networks utilizing aggregated signatures. The method can be performed by processing logic that can comprise hardware (circuitry, dedicated logic, etc.), software (such as is run on a computing device such as those described herein), or a combination of both. In one implementation, the described methods can be performed by one or more elements depicted and/or described in relation to FIG. 1 and/or FIGS. 2A-2B (e.g., browser 102, which may be a web browser or other such application that executes on a device, such as a device 210 as depicted in FIG. 2A or 2B and described in detail herein, service 220, etc.), while in some other implementations, the one or more operations can be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At operation 310, a first link is received. For example, as shown in FIG. 2A, user 230A (here, a ‘contractor’) can initiate a contract by executing dApp 212 and accessing or otherwise communicating with service 220 (e.g., platform/service 160 as depicted in FIG. 1 and described herein). In doing so, in certain implementations a key pair can be generated and/or retrieved (e.g., from secure storage). Such a key pair can include public key (‘PK’) 214A and private key (‘SK’) 216A. Alternatively, in certain implementations, an identifying parameter (e.g., an address associated with the first user) and an existing/previously generated first secret can be utilized. For example, as shown in FIG. 2A and described herein, public key 214A (or the referenced identifying parameter) can be written to the contract and stored on a public blockchain 240 (e.g., Ethereum). In other implementations, A link 250A can be generated which includes contract address 252 (e.g., the address of the smart contract on the blockchain, an Ethereum address, and/or an address at which service 220 maintains the details, parameters, etc. of the contract, campaign, etc.) and secret/private key 216A. User 230A can then disseminate link 250A (e.g., via social media, email, etc.). Additionally, in certain implementations the referenced first link further can also include a zero-knowledge cryptographic proof, as described herein.

User 230B can then receive or otherwise access such a link 250A. As noted, such a link can include or reflect a first secret/private key 216A (e.g., as generated with respect to or otherwise associated with a first user 230A). As noted, such a first private key 216A can correspond to a first public key 214A generated by the previous user in the chain (here, user 230A). Additionally, as noted, in certain implementations, such a first public key 214A can be associated with a contract (e.g., a smart contract, as described herein). Moreover, in certain implementations such a first link can also include a contract address, as described herein.

In certain implementations, the referenced first link 250A can initiate execution of a decentralized application. For example, upon accessing link 250A via a web browser, dApp 212 can execute on device 210B, as described herein.

It should be noted that while aspects of the described technologies are described with respect to ‘influencers’ and ‘converters,’ such descriptions are non-limiting and are only for purposes of illustration. Accordingly, it can be appreciated that the described technologies can be advantageously implemented in any number of other scenarios and contexts. Examples of such use cases include but are not limited to: voting, ticketing, recruiting, soliciting or collecting donations, crowdfunding, contest management, event tracking, etc.

Further aspects and implementations of the described technologies are described and depicted with respect to FIG. 2B. For example, in certain implementations, the described technologies can be configured to utilize a predefined secret and a hash function in connection with one or more of the described operations. In doing so, various efficiencies and optimizations can be realized, including further shortening the length/size of the link(s) described herein).

For example, in certain implementations the described contractor can pre-define or pre-generate multiple keys, e.g., using a hash function and a random number. The public keys generated by the contractor can be stored in the contract. Subsequent influencers in the ‘chain’ utilize these predefined keys in the manner described herein. In doing so, various advantages and improvements can be achieved. For example, in lieu of storing the referenced keys in the link (as described herein in other implementations), the described technique enables such keys to be stored in the contract. Additionally, the described techniques enable influencers to interact with and convert via the described links without needing to identify themselves (thereby enhancing privacy/enabling anonymity). Various aspects of the described cryptography, validation, and conversion operations can also change as a result of implementing the described predetermined/ pre-generated keys, the use of Schnorr signatures, and other modifications and improvements described herein.

For example, in certain implementations described herein, the address of the public key of each secret (which is 20 bytes) can be stored within the link. However, in other implementations a predefined secret can be used (e.g., in lieu of storing the public key in the link). As a result, the link length can be shortened to about 76+115*(n−1), thereby providing further efficiencies and optimizations, as described herein.

For example, as shown in FIG. 2B, user 230E (here, a ‘contractor’) can initiate a contract, e.g., by executing dApp 212 and accessing or otherwise communicating with service 220 (e.g., platform/service 160 as depicted in FIG. 1 and described herein). In doing so, in certain implementations a key pair can be generated and/or retrieved (e.g., from secure storage). Alternatively, in certain implementations, an identifying parameter (e.g., an address associated with the first user) and an existing/previously generated first secret can be utilized. For example, using a hash function and a random number, pre-defined or pre-generated keys can be utilized, as described herein.

As shown in FIG. 2B, in certain implementations such a user (e.g., ‘contractor’ 230E) can generated a first link 250D that includes, incorporates, and/or otherwise reflects elements including a first private key (e.g., as generated with respect to a first user) and/or various other elements such as are described herein. User 230E (or others) can then disseminate link 250D (e.g., via social media, email, etc.). Such a link 250D can thus be received by user 230F, as shown in FIG. 2B.

By way of further illustration, as shown in FIG. 2B, a contractor (which may be referred to herein as ‘I₀’) (e.g., 210E) can have an Ethereum (or plasma) address a₀, and generates a link (Link₁) (e.g., link 250D, as shown, and described in further detail herein). An influencer (which may be referred to herein as I₁) (e.g., 210F) can have an address a₁. Upon receiving, perceiving, or otherwise accessing Link₁ (e.g., link 250D, as shown in FIG. 2B), the influencer 210F can process/change it to a new link (Link₂) (e.g., link 250E, as shown). Moreover, this process can continue (e.g., with respect to other influencer(s)) until conversion by influencer Iₙ with address aₙ, as described herein. This process can be formally represented as:
I₀→Link₁→I₁→Link₂→ . . . →Linkⱼ→Iⱼ→Linkⱼ₊₁→ . . . →Linkₙ→Iₙ

As described herein, contractor I₀ (e.g., 250E as shown in FIG. 2B) can start a campaign by creating and initializing a contract (e.g., on Ethereum). Influencers Iⱼ can interact with such a contract, including by way of operations such as:

A ‘convert’ operation—Which may require them to send a transaction to the contract that proves they saw Linkⱼ.

Generating a link of their own Linkⱼ₊₁—In certain implementations, such an operation can be performed ‘off-chain’ and/or without using an Ethereum open wallet.

A ‘claim bounty’ operation—E.g., once a later influencer Iₙ has converted. Claiming a bounty can require Iⱼ (e.g., an influencer within the chain) to send a transaction to the contract that proves it was part of the link (Linkₙ) that was used in the later conversion.

As noted, Linkⱼ can refer to the link created by influencer Iⱼ₋ₗ which may be known to influencer(s) that saw this link. Iⱼ refers to the influencer that saw this link and is part of the path to the conversion of Iₙ and has an address aⱼ.

I^{e}ⱼ can refer to another ‘evil’ influencer, which can be a ‘sibling’ to Iⱼ, which is not directly involved in the conversion of Iₙ, it has an address a^{e}ⱼ. This ‘evil’ sibling also saw Linkⱼ and is in the best position to attack Iⱼ and try to grab his bounty. I^{e}ⱼ can legally convert and create his own link which can later turn into a conversion which is different from the conversion of Iₙ.

As described herein, anything sent to Ethereum (or another public blockchain or decentralized network) may become publicly accessible. Any pre-agreed constants described herein may also be public. For example, a point ‘G’ on the described elliptical curve can be hardcoded in the dApp code and in the contract In accordance with the properties of elliptical curves, if we have a secret number x or k and we multiply it with G, the result is a new point on the curve P=xG or R=kG, which can be made public (for example, by sending it to the blockchain, without exposing what x or k was).

It should be understood that in various formulas provided herein, lower case letters can refer to integers (e.g., 256 bits, 32 bytes, etc.) and uppercase letters can refer to points on an elliptic curve. Computation with integers can be module n_{G} the order of the group G.

Accordingly, in certain implementations, Link (e.g., links 250D-F as depicted in FIG. 2B and described herein) can be structured or configured as a ‘triplet’ that includes:
Key (xⱼ)—e.g., an integer.
An aggregated signature (Σᵢ₌₁^{j-1} sᵢ)—e.g., an integer.
One or more public keys ([R₁, . . . , Rⱼ₋₁])—e.g., an ordered list of points on the curve, one for each influencer I₁, . . . , Iⱼ₋₁ (as described herein, the secret of each R is itself a signature). The length of this dictates what j is.

The contractor I₀ (e.g., 210E as shown in FIG. 2B) can generate value x₁ (e.g., a random value) and store its public key in the contract so it becomes public (P₁ =x₁ G) (e.g., public key 214A as shown in FIG. 2B). Additionally, in certain implementations the contractor can secretly generate a sequence of values xₙ=h(xₙ₋₁), e.g., using a hash function h( ). The corresponding public values can be stored in the contract (Pₙ=xₙ G), e.g., until a maximal number of allowed hops (N).

In certain implementations, different hash functions may be used in different parts/operations described herein. For example, different hash functions can be used when computing Pᵢ by the contractor, when Iₙ is converting or when building the new link by the influencer Iⱼ, as described herein. In certain implementations Iⱼ may even use a different hash function when computing sⱼ and kⱼ.

The root link itself (e.g., link 250D as shown in FIG. 2B) can be x₁ (Link₁=x₁,0,[ ]), e.g., in a triplet format.

In certain implementations, the various xₙ may need to be valid between xₙ ∈ 1 . . . n_{G}−1. If not, the contractor may need to repeat the process, e.g., by starting from a different random x₁.

At operation 320, a key, key pair/value, etc. can be generated and/or retrieved (e.g., from secure storage), e.g., with respect to a second user. For example, as shown in FIG. 2A, having executed dApp 212, device 210B can generate a key pair that includes, for example, a second secret/private key 216B and a second public key 214B.

As noted above, in certain implementations (such as is depicted in FIG. 2B), the contractor (210E) can generate value x₁ (e.g., a random value). Additionally, in certain implementations the contractor creates x₁, influencer xⱼ and kⱼ, and converter k*ₙ. These values can be securely random and the influencer needs to retain their public part Pⱼ and Rᵢ in order to claim their bounty. To overcome these problems, it can be advantageous to deterministically generate these values from the wallet of the contractor, influencer, or converter respectively.

For example, a wallet (e.g., of contractor 210E as shown in FIG. 2B described herein) can be configured to create an elliptic curve digital signature algorithm (ECDSA) signature of a new message. As described herein, this signature can be kept secret and used to derive the various random numbers, e.g., using repeated calls to a hash function.

It should be understood that each random number should not be used in two different situations. Accordingly, parameters that may change over time (e.g., the contract address, the contractor/influencer/converter address) should be added to the hash process.

At operation 330, a cryptographic signature or proof can be computed. In certain implementations, such a proof/signature can be, for example, a signature of the second public key (e.g., public key 214B as generated or retrieved at operation 320) and various parameter(s) associated with the second user (such as its address, e.g. on Ethereum, its weight, etc.). Additionally, in certain implementations such a proof/signature can be computed, for example, using the first secret/private key (e.g., secret/private key 216A, as received within link 250A at operation 310). In certain implementations, such a proof can be a zero-knowledge cryptographic proof, e.g., a proof that the second user (e.g., user 230B) received, knew, or otherwise had access to the first secret/private key (e.g., secret 216A). Additionally, in certain implementations such a proof can require knowledge of an identifying parameter (e.g., an address or public key) associated with the second user, as well as other parameter(s) (e.g., those added to the second link by the second user), as described in detail herein. Moreover, in certain implementations the referenced proof can be a zero-knowledge cryptographic proof that the second user knew the value of the first secret without exposing the first secret (e.g., as described herein). Additionally, in certain implementations the referenced proof can be a cryptographic signature in which the identifying parameter associated with the second user is signed with the first secret. Additionally, in certain implementations the referenced proof can be a cryptographic signature of an identifying parameter associated with the second user (the cryptographic signature being generated using the first private key) (e.g., as depicted with respect to FIG. 2B and described herein).

In certain implementations, such a proof/cryptographic signature can be computed via a decentralized application, e.g., as accessed via the first link 250A, as described herein. For example, the referenced proof/cryptographic signature can sign various parameters associated with the second user, such as the second public key, an address associated with the user, parameter(s) that define aspect(s) of a subsequent dissemination of the link, a contract address, an identifier/identifying parameter associated with the second user, a weight assigned by the second user, parameter(s) provided by the first user within the first link, parameter(s) corresponding to other user(s) associated with the first link (e.g., users other than the first user and the second user), content from the first link (e.g., without the first secret/private key) etc., as described herein. Additionally, in certain implementations one or more of the described proofs/signatures can be aggregated, e.g., as described herein. For example, in certain implementations the first link can include a zero knowledge cryptographic proof and the computed zero knowledge cryptographic proof (e.g., as computed at operation 330) can be aggregated into such a zero knowledge cryptographic proof included in the first link the referenced proof, as described herein.

By way of further illustration, as shown in FIG. 2B and described herein, to join a link (e.g., link 250D), the first influencer (e.g., 210F) creates his own link (250E) by generating a new secret key x₂=h(x₁). If the influencer only uses x₂ as the link then the following influencer I₂ may not be able to validate that the influencer before was I₁ and not some other influencer I^{e}₁ who saw x₁. To avoid this I₁ can add a signature to the link: s₁=k₁+h(R₁)x₁.

As described herein, a following influencer I_{2 . . . n} wishing to convert may be forced to use this signature. This can require R₁=k₁G to be known so it is also needed in the link. It should be understood that k*₁, R*₁ are different from k₁, R₁.

Accordingly, in certain implementations the final link can include the following components: Link₂ =x₂, s₁,[R₁]

In subsequent links, the last component [R₁] can expand to an ordered list of Rs, one for each influencer, e.g., as shown in FIG. 2B (e.g., in links 250E and 250F). As with k*₁, it may be possible for I^{e}₁ to know k₁ (k₁ can be computed in a manner described herein). Note that the next influencer I₂ that only knows Link₂ may not be able to reproduce x₁ or k₁.

At operation 340, a second link is generated (e.g., link 250B, as shown in FIG. 2A). In certain implementations, such a second link can include a second secret/private key (e.g., secret/private key 216B as generated at operation 320 and/or otherwise associated with the second user) and the proof/cryptographic signature (e.g., signature 218B, as computed at operation 330). In certain implementations, the second link can also include content from/originating at the first link (e.g., without the firsts secret/private key). For example, as shown in FIG. 2A, link 250B can include contract address 252 which originated from link 250A, as described herein.

Additionally, in certain implementations the referenced second link can include various additional information, fields, elements, etc. In certain implementations, such elements can be stored in a ‘message’ field or segment (e.g., message 217B, as shown in FIG. 2A), as described in detail herein. For example, in certain implementations the referenced second link can include identifying parameter(s) associated with the second user, such as the address (e.g. on Ethereum) of the second user, as well as other parameter(s) such as those that define aspect(s) of a subsequent dissemination of the second link (e.g., how a bounty should be divided, allocated, etc. among influencers), as described herein.

Additionally, in certain implementations the referenced second link can include a reference to a storage resource (e.g., a link to IPFS or another storage service, location, etc.) that stores the second secret/private key, the cryptographic proof/signature, and/or other parameter(s) referenced herein. Doing so can enable the link size to remain relatively small.

In certain implementations, the referenced second link can also include a proof, signature, etc. generated using another secret/private key associated with the second user (e.g., an Ethereum private key). In doing so, the user can verify his/her identity, as described in detail herein.

Additionally, in certain implementations the referenced second link can include other parameters (e.g., within the referenced ‘message’ segment 217B) such as identifying parameter(s) associated with the second user, such as the address (e.g. on Ethereum) of the second user, a weight assigned by the second user, an address associated with the first user, etc. Moreover, in certain implementations the referenced second link can include other parameters that correspond to or reflect other users associated with the first link (e.g., prior influencers in a chain), as described herein. For example, in certain implementations the referenced parameter(s) (which may be added by various ‘influencers’ as the link is passed) can be maintained in the referenced ‘message’ segment In doing so, for example, the referenced address of each user (and other associated parameters) can be maintained in the link as it is passed, as described herein.

By way of further illustration, in certain implementations (e.g., as depicted in FIG. 2B and described herein) a second link can be generated which includes, incorporates and/or otherwise reflects a second private key, the cryptographic signature of the first private key, and one or more public keys, as described herein. For example, an influencer I, that obtains or receives root link Link, can identify, determine, or otherwise obtain the key generated by the contractor x₁. This key can be used by the influencer to generate a Schnorr signature, e.g., by generating a secret random number k*₁ ∈ 1 . . . n_{G}−1 with its public part R*₁ =k*₁ G and then s*₁=k*₁+h(R*₁∥a₁) x₁ (R is to be part of the hash in order to avoid the need to be interactive).

This signature s*₁ and R*₁ can become public (e.g., sent to the contract) without exposing k*₁ or x₁. Another influencer I^{e}₁ which knows x₁ can be capable of computing k*₁ from s*₁.

The influencer I₁ can convert by sending the signature s *₁,R*₁ and a₁ to the contract's conversion method, as described herein. In doing so, the signature can be validated e g by validating s*₁G==R*₁+h(R*₁∥a₁)P₁ (where P₁ is read from the contract). Doing so confirms that influencer with address a₁ received/had access to the root link.

It should be understood that, in certain implementations, a₁ can be the address of the sender of the Ethereum transaction. This proves that I₁ owns a₁ and therefore may send a signature s*₁ in which a₁ is used.

Additionally, in certain implementations I^{e}₁ can compute s*₁. It can be appreciated that without this check it may be possible for I^{e}₁ to send a transaction with s*₁ that converts I₁ without I₁ permission Alternatively, I₁ can have a different address (though the contract may be pre-configured with a mapping that converts the address to a₁ in a trusted way. In yet another alternative, a centralized service (configured with permission to do so) sends s*₁ to the contract.

Additionally, the described operation(s) can be repeated, e.g., with respect to additional influencers, as described herein. For example, a third private key can be generated (e.g., with respect to a third user, such as 230H as shown in FIG. 2B). Using the third private key, a cryptographic signature of the second private key can be computed, as described herein. A third link (e.g., link 250F as shown in FIG. 2B) can be generated. Such a link can include the third private key, the cryptographic signature (e.g., an aggregated cryptographic signature, a Schnorr signature, etc., as described in detail herein) of the second private key, one or more public keys comprising a public key corresponding to the first private key (e.g., R₁ as shown in FIG. 2B and described herein) and a public key corresponding to the second private key (e.g., R₂ as shown in FIG. 2B and described herein).

By way of further illustration, to join a link the first influencer creates his own link by generating a new secret key x₂=h(x₁). If the influencer only uses x₂ as the link then the following influencer I₂ may not be able to validate that the influencer before was I₁ and not some other influencer I^{e}₁ who saw x₁. To avoid this I₁ can add a signature to the link: s₁=k₁+h(R₁)x₁

As described herein, a following influencer I_{2 . . . n} wishing to convert may be forced to use this signature. This can require R₁=k₁G to be known so it is also needed in the link. It should be understood that k*₁, R*₁ are different from k₁, R₁.

Accordingly, in certain implementations the final link can include the following components: Link₂=x₂, s₁,[R₁] (e.g., as shown in FIG. 2B with respect to link 250E).

In subsequent links (e.g., link 250F as shown in FIG. 2B), the last component [R₁] can expand to a list (e.g., an ordered list) of Rs, one for each influencer. As with k*₁, it may be possible for I^{e}₁ to know k₁ (k₁ can be computed in a manner described herein). Note that the next influencer I₂ that only knows Link₂ may not be able to reproduce x₁ or k₁.

At operation 350, the second link (e.g., as generated at operation 340) can be disseminated (e.g., via web 2.0 services or any other such techniques). Subsequent users (e.g., user 230C) can access the link and perform comparable operations with respect to it. One or more user(s) (e.g., user 230D) may ultimately convert via such a link, as described in detail herein.

As described herein, the influencer can perform operations to claim a bounty, e.g., when a conversion is performed by a later influencer Iₙ (where n>1). As described herein, such conversion operation(s) can require the converter to send R₁ (among other parameters) to the contract (e.g., as stored in Ethereum or on another blockchain). The contract can store R₁ and I₁ can use this stored value (that is associated with the conversion) to prove he contributed to the Iₙ conversion (and therefore is entitled to claim his bounty).

In certain implementations, I₁ can prove he owns R₁ using k₁, though he can't use it as a random private key because it may be known to I^{e}₁. Instead, in the previous step, when I₁ creates his link (Link₂) he can use a k₁ that is a signature and not a random number: the influencer I₁ generates random key x₁ ∈ 1 . . . n_{G}−1 with a public counterpart P₁=x₁G.

Additionally, in certain implementations I₁ can also generate a random number k₁ ∈1 . . . n_{G}−1 with its public counterpart R₁=k₁G and computes the signature k₁=k₁+(R₁∥P₁∥a₁)x₁. The signature k₁ can appear random and can be used as a masking value when computing s₁.

It should be noted that a₁ can be ‘hidden’ inside k₁which is itself ‘hidden’ inside R₁. As a result, the identity of the influencer can be ‘hidden’ inside the link (the influencer can also remain hidden until he claims his bounty). In certain implementations, the same influencer I₁ can use the same k₁, x₁ and R₁ (or an address of it) can be used as a temporary identifier of the influencer, e.g., until his real identity is revealed.

When claiming a bounty (e.g., with respect to I₁) it may be advantageous to prevent k₁ from becoming public because doing so allows I₂ to derive x₁ (because he already knows s₁ from the link). Instead, in certain implementations I₁ sends R₁, R₁ and P₁ to the contract. Such information can be sent from address a₁, as described herein.

The contract can first validate that R₁ was used in the conversion and further validates that R₁==R₁+h(R₁∥P₁∥a₁)P₁, thereby proving that a₁ owns R₁. I^{e}₁ may know k₁ but it would be difficult for I^{e}₁ to ‘fake’ this claim using his address a^{e}₁, since R₁ is already defined before the claim is made. I^{e}₁ may know k₁ in addition to R₁ and though he can select any R₁, P₁, the hash h(R₁∥P₁∥a₁) causes it to be computed only after R₁ and P₁ are selected (so he can't derive them directly from R₁ and will need to guess their values). Additionally, I^{e}₁ may also know k₁ but the same argument applies to finding a k₁, x₁ pair that will give a predefined k₁.

Accordingly, during an ‘attack’ (e.g., an attempt to claim a bounty by a participant not entitled to do so), the ‘evil’ or unauthorized influencer I^{e}₁ can merely generate an unauthorized link on behalf of I₁ via the described computation. The attacker can publish R₁,P₁ to claim that I₁ has generated the link. But if a₁ is taken from the transaction then I^{e}₁ can not make the claim on behalf of I₁. In another implementation, I₁ can replace a₁ with a signature (ecdsa) generated with the wallet of a₁. To protect against reuse of this signature, the message being signed can be the contract address c and the index of the influencer in the link (1 for first influencer): k₁=k₁+h(R₁∥P₁∥ecdsa(c∥1,a₁))x₁.

When claiming a bounty, I₁ can supply the signature ecdsa(c∥1,a₁) together with R₁ and P₁ which may not be known until I₁ makes his claim.

Moreover, in certain implementations the n-th influencer Iₙ∀n>0,n≤N finds the link from the previous influencer: Linkₙ=xₙ, Σᵢ₌₁ⁿ⁻¹ sᵢ,[R₁, . . . , Rₙ₋₁].

Influencer Iₙ with address aₙ can convert by generating a random k*ₙ ∈ 1 . . . n_{G}−1 and computing as before:

R*ₙ=k*ₙG

s*ₙ=k*ₙ+h(R*ₙ∥aₙ)xₙ+Σᵢ₌₁ⁿ⁻¹ sᵢ

and sending s*ₙ to the contract with aₙ and [R₁, . . . , Rₙ₋₁],R*ₙ.

In certain implementations, the contract can validate as follows:

$${s}_{n}^{*} G == {R}_{n}^{*} + h ( {R}_{n}^{*} ∥ {a}_{n} ) {P}_{n} + {\sum }_{i = 1}^{n - 1} ( {R}_{i} + h ( {R}_{i} ) {P}_{i} )$$

It can be appreciated that for the n-th influencer the P₁, . . . , Pₙ are predetermined. Accordingly, generating a solution R*ₙ can be difficult if the influencer does not know xₙ when generating s*ₙ, even if he can choose any value he wants for [R₁, . . . , Rₙ₋₁].

With respect to the link, as before xₙ ∈ 1 . . . n_{G}−1 and kₙ ∈ 1 . . . n_{G}−1 are random and we have:

Pₙ=xₙG,

Rₙ=kₙG,

kₙ=kₙ+h(Rₙ∥Pₙ∥aₙ)xₙ or replacing aₙ with ecdsa(c∥n,aₙ)

Rₙ=kₙG

sₙ=kₙ+h(Rₙ)xₙ

xₙ₊₁=h(xₙ)

And the new link is:

Linkₙ₊₁=xₙ₊₁,Σᵢ₌₁ⁿ sᵢ, [R₁, . . . , Rₙ₋₁, Rₙ]

In certain implementations, the signature kₙ can be extracted by a malicious sibling I^{e}ₙ and added to a different link, which is not necessarily an unwanted result for Iⱼ. However, as noted above, in certain implementations only the valid influencer Iⱼ is able to send a transaction to the contract with Rₙ,Pₙ,aₙ. In an alternative implementation, it is also possible to add R₁∥ ... ∥Rₙ₋₁ to the hash when computing kₙ. Doing so can, for example, block reuse of kₙ, e.g., in unwanted links.

As also described herein, it may be advantageous in certain scenarios to shorten the generated link. Doing so may be advantageous since the link and the information sent to the contract in a transaction grows with the number of ‘hops’ in the chain because of the growth of the list [R₁, . . . , Rⱼ, . . . , Rₙ] and this list can be stored in the contract. This allows link(s) generated after this storage to use a single identifier (e.g., a 256-bit integer) to identify a prefix of this list. In certain implementations, doing so can entail, for example, substituting, within the second link, an integer for the one or more public keys.

For example, integer r may identify the list [R₁, . . . , Rⱼ] stored in the contract. This allows any influencer Iⱼ, or any influencer that follows it, to replace the prefix [R₁, . . . , Rⱼ] and instead send rⱼ. In doing so, the composed link of a later influencer Iⱼ can be:

Linkₙ₊₁=xₙ₊₁,rⱼ,[Rⱼ₊₁, . . . , Rₙ], Σᵢ₌₁ⁿ sᵢ

The link can be shortened by Iⱼ or his followers (e.g., at any time). For example, such influencer(s) can have the option to either use the original link length or the shortened link. This shortening can also be used when sending the list [R₁, . . . , Rₙ] to the contract (e.g., even if the link itself is kept in its full length).The referenced link shortening can also be performed in other ways, e.g., via an external service configured to perform such transactions (e.g., to pay the gas for all the converters). The service can send information Rⱼ related to each influencer or converter to the contract (e.g., only once), irrespective of the structure of the conversion tree. In certain implementations, doing so can entail, for example, shortening the second link via an external service.

In certain implementations, the described contract can be optimized in various ways. For example, the contract can be optimized by saving intermediate results of the conversion: Σᵢ₌₁^{j}(Rᵢ+h(Rᵢ)Pᵢ). This value can be recalled later, e.g., when receiving a later transaction that starts with rⱼ, or other transactions that start with the same prefix and then diverge, e.g.,: [R₁, . . . , Rⱼ,R^{e}ⱼ₊₁,R^{e}ⱼ₊₂, . . . , R^{e}ₘ].

Additionally, in certain implementations various other optimizations can be employed, e.g., when Iⱼ creates a new link (Linkⱼ₊₁). However, this optimization may apply to the new link (not necessarily the code of prior links). Iⱼ can claim the previous transaction that was sent to the contract with [R₁, . . . , Rⱼ, . . . , Rₙ] has proven that Iⱼ is the j-th influencer and therefore Linkⱼ₊₁ (or links that follow it) can start with a signature that starts with the j-th element Accordingly, such a link can be constructed as: Linkⱼ₊₁=xⱼ₊₁,j,rⱼ,[ ],sⱼ, and link(s) that follow it can be constructed as: Linkₙ₊₁=xₙ₊₁,j,rⱼ,[Rⱼ₊₁, . . . , Rₙ], Σᵢ₌ⱼⁿ sᵢ.

Additionally, in certain implementations influencers can add their own parameter (pₙ) to the link. Such parameters can include, for example, parameters that define one or more aspects of a subsequent dissemination of the second link, a contract address, an identifier associated with the second user, or a weight assigned by the second user, parameters provided by the first user within the first link, parameters comprise one or more parameters associated with the second user, etc., as described herein. For example, an influencer can add a byte to the link that reflects the fee (or ‘cut’) the influencer wishes to obtain from the bounty. In this case the equations can be modified as

sₙ=kₙ+h(Rₙ∥pₙ)xₙ

Linkₙ₊₁=xₙ₊₁,Σᵢ₌₁ⁿ sᵢ, [R₁, . . . , Rₙ₋₁,Rₙ], [p₁, . . . , pₙ₋₁,pₙ]

The converter can also send [p₁, . . . , pₙ₋₁] to the contract. The contract can validate these values as follows:

$${s}_{n}^{*} G == {R}_{n}^{*} + h ( {R}_{n}^{*} ∥ {a}_{n} ) {P}_{n} + {\sum }_{i = 1}^{n - 1} ( {R}_{i} + h ( {R}_{i} ∥ {p}_{i} ) {P}_{i} )$$

and then the contract can use or account for the [p₁, . . . , pₙ₋₁] values internally. In doing so, the bounty of the conversion can be distributed, e.g., between the different influencers.

In certain implementations, the referenced bounty can be claimed in substantially the same manner described herein with respect to the first influencer. For example, if Iₙ converted, an influencer Iⱼ ∀n>j>0 that contributed to the conversion can send his Rⱼ,Pⱼ and aⱼ. The contract computes that Rⱼ==Rⱼ+h(Rⱼ∥Pⱼ|aⱼ)/Pⱼ or replacing aⱼ with ecdsa(c∥j,aⱼ) and compares to the stored Rⱼ.

With respect to the elliptic curve referenced herein, it can be appreciated that certain implementations may need to account for verification being performed using Ethereum virtual machine (EVM), which each operation requires ‘gas.’ This can be used in determining the selection of the elliptical curve (“EC”) to use. The EC used in Ethereum signatures is secp256k1 however the EVM does not provide a direct low gas cost option of performing various scalar multiplications (e.g., x*G). However, it is possible to utilize functions such as ecrecover to validate that a point on the curve P as sent to the contract is equal to x*G. In certain implementations, doing so can require the dApp to compute the intermediate results of the referenced scalar multiplications. Estimated gas cost is about 10 K. Such a curve can require 32 bytes+1 bit for sending a point on the curve. Though an entire byte may be wasted for the single bit, the single bits can be concatenated, e.g., for all the Rᵢ in the link.

An alternative curve is alt-bn128 which has an Ethereum precompiled scalar multiplication contract (e.g., ECMUL, BN_MUL). Currently estimated gas costs are 6 K to perform the described scalar multiplication (e.g., in Ethereum ‘Istanbul’), though such costs may change in other variations or forks. Such a curve may require only 32 bytes for sending a point on the curve.

Additionally, in certain implementations the described links can be configured to utilize Unicode characters (or other character sets, encodings, etc.) to encode and/or otherwise express the described links In doing so, the visual representation of the described links can be minimized, which can be advantageous in various interfaces and other contexts. It should be understood that the described technique can be utilized in practically any scenario or context, including those involving links unrelated to those described herein. For example, any hyperlink can be converted or otherwise encoded in one of the referenced character sets (e.g., Unicode), to enable the visual representation of the hyperlink to be minimized (or otherwise take on various desired visual properties).

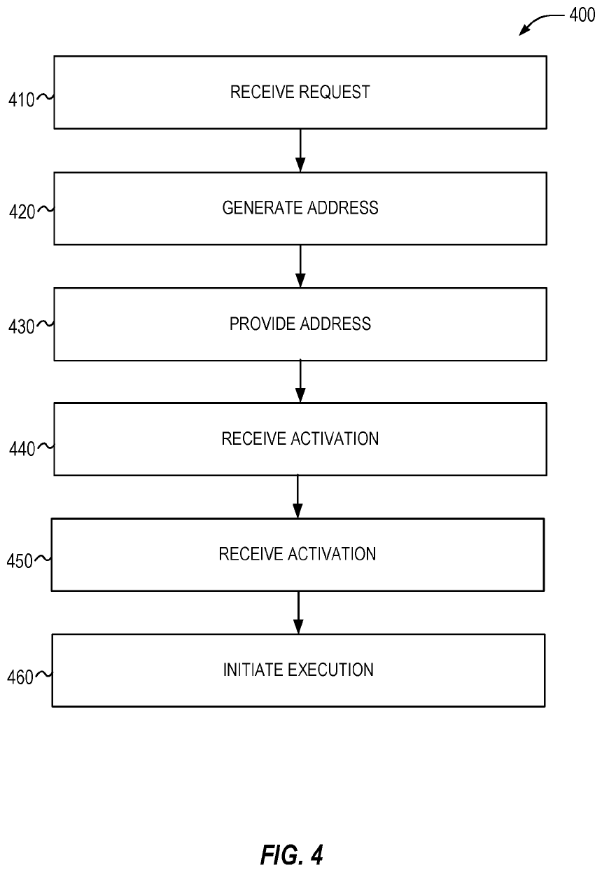

FIG. 4 is a flow chart illustrating a method 400, according to an example embodiment, for implementing a decentralized protocol for maintaining cryptographically proven multi-step referral networks. The method can be performed by processing logic that can comprise hardware (circuitry, dedicated logic, etc.), software (such as is run on a computing device such as those described herein), or a combination of both. In one implementation, the described methods can be performed by one or more elements depicted and/or described in relation to FIG. 1 and/or FIG. 2A (e.g., platform 160, service 220, device(s) 210, etc.), while in some other implementations, the one or more operations can be performed by another machine or machines.

At operation 410 a contract initiation request is received, e.g., from a first user. For example, as shown in FIG. 2A, user 230A can utilize device 210A to activate dApp 212 and interface with service 220 in order to initiate a contract. Such a contract initiation request can include various parameter(s) associated with the contract (e.g., the type of contract, length of time, maximum number of influencers, bounty, etc.), as described in detail herein. Additionally, the referenced contract initiation request (e.g., as received by service 220 from device 210A) can also include identifying parameter(s) associated with the first user, such as an address (e.g. on Ethereum) of the first user and/or a public key associated with the first user (e.g., public key 214A, as described herein). Additionally, in certain implementations the referenced contract initiation request can also include a bounty provided by the first user (e.g., upon conversion). By way of further example, as shown in FIG. 2B, user 230E can utilize device 210E to activate dApp 212 and interface with service 220 in order to initiate a contract, as described herein.

At operation 420, a contract address is generated (e.g., by service 220), e.g., in response to the contract initiation request (e.g., received from user 230A/230E).

At operation 430, the contract address (e.g., contract address 252 as generated at operation 420) is provided the to the first user (e.g., user 230A). As shown in FIG. 2A and described herein, such a contract address can be incorporated into link 250A and disseminated by user 230A. Additionally, as shown in FIG. 2B and described herein, such a contract address can be incorporated into or associated with link 250D and disseminated by user 230E.

At operation 440, an activation of a first link (e.g., link 250A/250D) can be received, e.g., from/with respect to a second user (e.g., user 230B/230F). As noted, the referenced first link (250A) can include the contract address (e.g., contract address 252, as generated at operation 420). Additionally, such a first link (250A)—which is activated by the second user 230B—can be generated by the first user 230A, as described herein. Additionally, in certain implementations an activation of a first link (e.g., link 250D as shown in FIG. 2B) can be received from a second user, such a link (250D) corresponding to the contract address and generated by the first user, the first link comprising a first private key generated with respect to a first user, as described herein.

At operation 450, an activation of a second link is received, e.g., from/with respect to a third user (e.g., user 230C). As noted, the referenced second link (250B) can include the contract address (e.g., contract address 252, as generated at operation 420). Additionally, such a second link (250B)—which is activated by the third user 230C—can be generated by the second user 230B, as descried herein. Additionally, in certain implementations an activation of a second link (e.g., link 250E as shown in FIG. 2B) can be received, e.g., from a third user (e.g., user 230H), such an activation of a second link being generated by the second user (230F) and comprising a second private key, a cryptographic signature of the first private key (e.g., an aggregated cryptographic signature, Schnorr signature, etc.), and one or more public keys, as described herein. Additionally, in certain implementations such a second link can include various parameters such as parameters that define one or more aspects of a subsequent dissemination of the second link, a contract address, an identifier associated with the second user, or a weight assigned by the second user, etc., as described herein.

As described in detail herein, the described operations can be repeated with respect to multiple additional users, thereby increasing the referral chain.

At operation 460, an execution of the contract can be initiated, e.g., with respect to one or more users. In doing so, one or more signatures within the link (through which the conversion occurred) can be validated, as described in detail herein.

Further aspects of the described technologies are depicted and described with respect to method 510, as shown in FIG. SA. For example, in certain implementations, the referenced business can create (e.g., with a dApp such as a web page containing JavaScript code/framework 104 running on her browser 102, which may be a web browser or other such application that executes on a device, such as a device 210 as depicted in FIG. 2A and described in detail herein), an Ethereum contract that contains information associated with a product (e.g., the price of a unit sold in the contract and optionally a reference for content describing the product being sold) (511).

The referenced business can also decide or dictate the maximal number of influencers in a path from the business to the customers (512). For example, the business can dictate at most one influencer and a customer so the maximal depth is N=2. The dApp generates a secret random number s_0 (513) and computes its hash: H=hash(hash(s_0)) the hash is applied N times (514). H and the maximal depth N=2 can also be stored in the contract (e.g., as part of its creation) (515-516).

The referenced dApp can creates a link (517) (e.g., a zk link) which contains the secret s_0 in addition to the contract address. For example: 2key.co/?c=<contract>&s=<s_0>. The business can publish the link (518) hoping it will reach as numerous influencers and customers.

It should be understood that in the described scenario, the contractor is responsible to store the public information about the link (e.g., H and N) inside the contract.

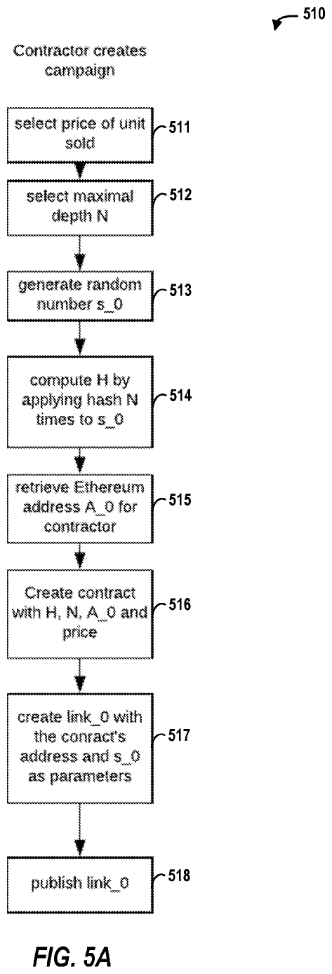

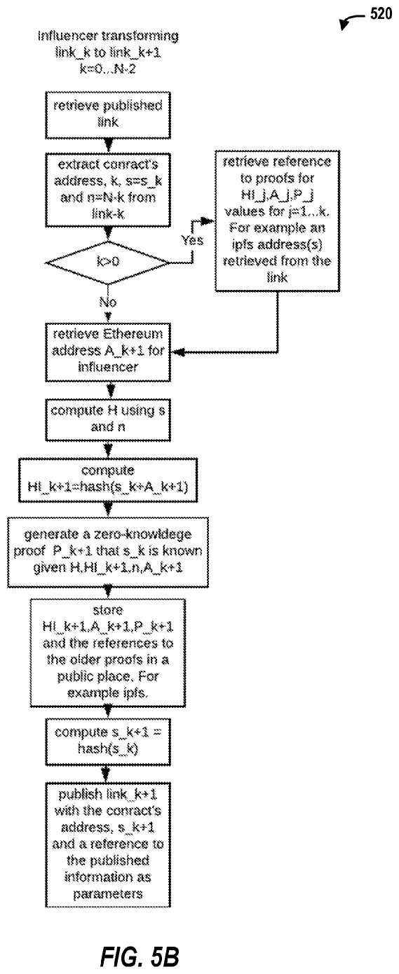

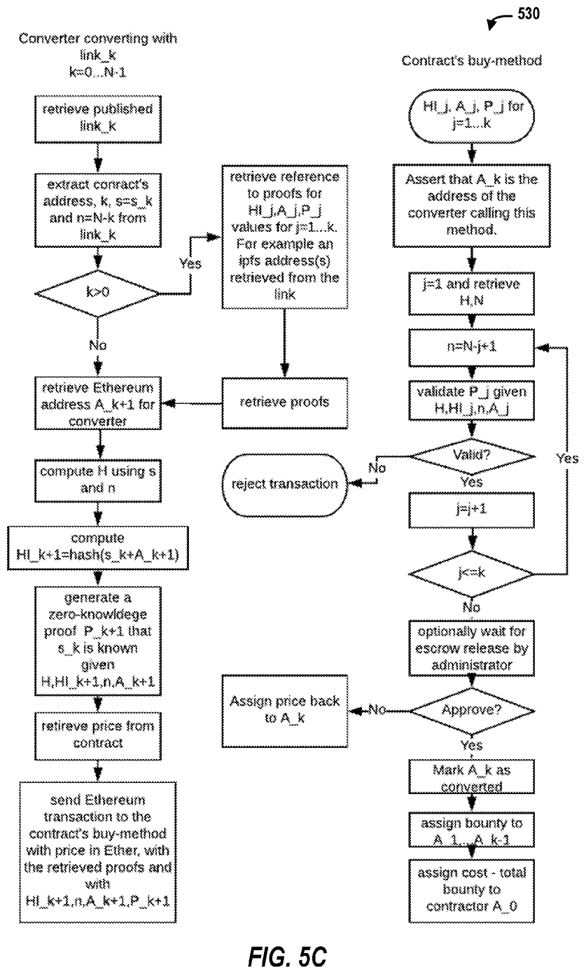

Additionally, in the various methods described (e.g., zk or signature, such as are depicted in FIGS. 5A-5C, 6A-6C, and 7A-7C and described herein) the referenced link begins with public information which is stored in the contract. The contractor can, for example, both create the first link and store the information in the contract.

However, once an information about an influencer is written in the contract (e.g., when a conversion occurs, and the influencer receives an ARC token on the contract, proving he was the influencer to the conversion) the influencer may elect to start his own link. Once such an on-chain proof occurs, the influencer can store the public part of the link it created inside the contract It can be appreciated that, as far as such a newly created link is concerned, the influencer is acting as the contractor for that link.

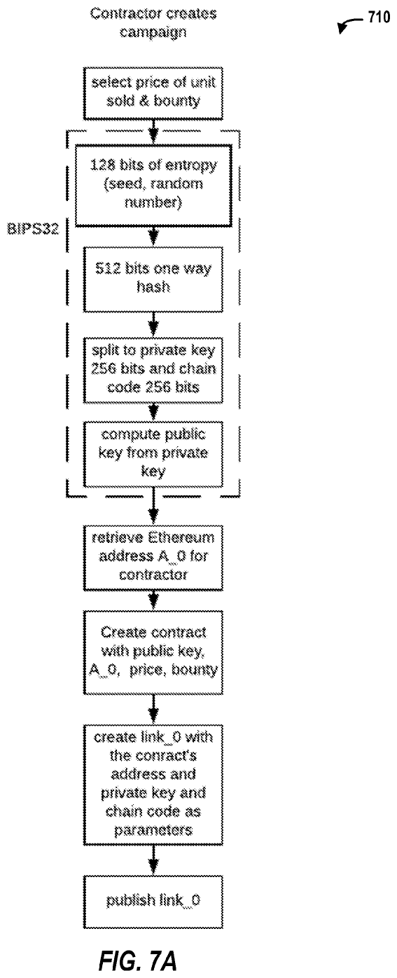

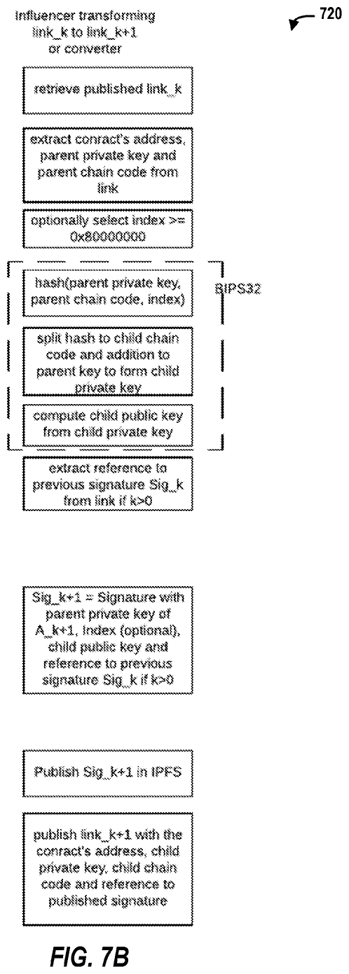

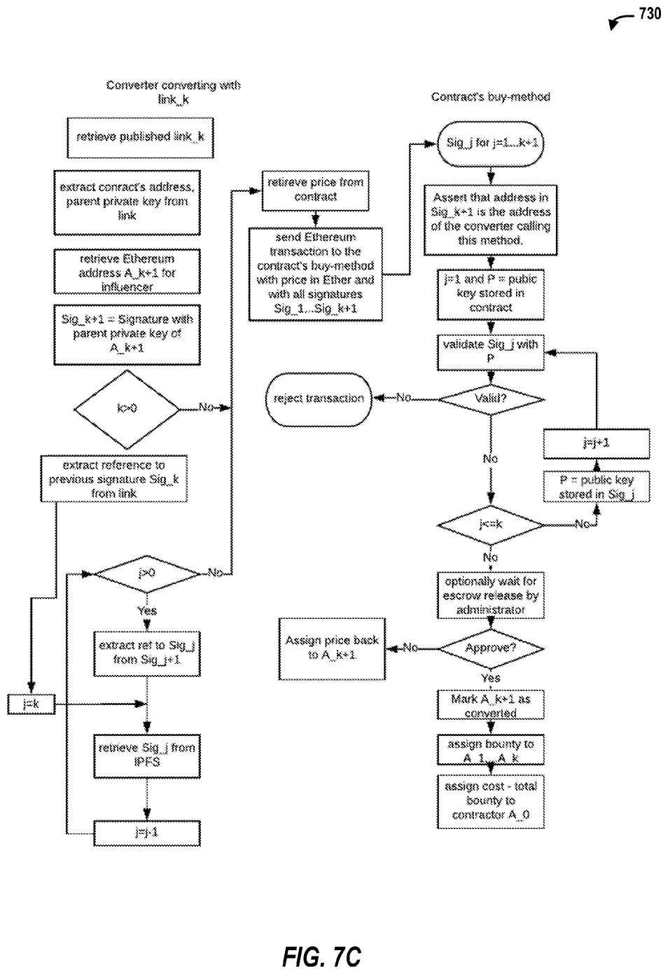

FIG. 7B depicts aspects of an example method 720 in which an influencer transforms a link (e.g., the link created in FIG. 7A), e.g., in a manner described herein. FIG. 5C depicts aspects of an example method 530 in which a converter converts (e.g., executes a transaction, etc.) via one of the described links (e.g., a link created in FIG. 5A and/or disseminated in FIG. 5B), e.g., in a manner described herein.

By way of further illustration, ‘customer 1’ can be a customer that found the link as it was published by the business. She opens the link in her browser. The browser fetches the dApp from a website and runs it. The dApp can, among other things, retrieve and display the description of the contract “c”.

In certain implementations, the dApp can include a ‘BUY’ button (or any other such selectable control). When selected, pressed, activated, etc., the secret “s” can be processed from the link. In certain implementations, a naive solution can be for the dApp to send the secret to the contract's buying method with the amount of ETH needed to buy the product sold in the contract (and ‘gas’). The contract can validate that H==hash(hash(s_0)) (hash is applied twice because in this example when the maximal depth N is 2, in general the hash will be applied N times). The customer can thus ‘prove’ or verify to the contact that she had access to the original link and the contract will allow the purchase to proceed/execute.

The contract can also maintain/keep a track of the accumulated ETH balance for each user. The ETH can be kept in escrow for a later release by a contract escrow administrator or it can be added to the business's accumulated balance. The business can later redeem the ETH accumulated balance.

Zero-knowledge proof—Being that transactions on the blockchain are publicly accessible, anyone can read the secret s_0 from them. Accordingly, in certain implementations the described technologies can be configured to enable the customer to send a zk (zero-knowledge) proof or verification that she knows the secret (without actually sending it). In certain implementations, such a proof can be generated by calling special code inside the dApp. The proof can demonstrate that dApp knew the value of a secret ‘s’ and it proves it by running the pseudocode (e.g., as shown below) with publicly known values H, n, HI and A and with a secret value s:

def verify(H,n,HI,A,s):
assert(HI==hash(s+A)
assert(H==hash\hat{ }n(s))//apply hash n times
return 1

The referenced pseudocode can be used for various usages of the contract. For example, it can be compiled and converted into JavaScript code for generating proofs as part of the dApp's code For example, operations such as ‘compute-witness’ and ‘generate-proof’ can be used (e.g., as found in ‘zokrates’). In addition, the compilation can place a library on Ethereum to verify the proof and to be used by other zk contracts. For example, using the referenced compile, setup and export-verifier steps.

The dApp can also create the proof to be used as input, along with public values, to the Ethereum verify library. It does this, for example, by running the JS code with the following parameters:

A is the Ethereum address of the person running the dApp

s is the secret (for now s_0)

H=hash(hash(s))

n=N=2

HI=hash(s+A)

The result is a proof P which is a list of values.

Customer using ZK—The customer's dApp sends P, A and HI to the contract. The contract can know or identify H, n=N and verifies that P is valid and allows the purchase to be made. The values P, A, N, HI and H are now all public but it is impossible to recreate s and the original link from them.

By way of further illustration, ‘Influencer 1’ can be an influencer that found the link as it was published by the business.

The dApp's JOIN button or control can convert the link to a new link which adds the influencer. In doing so, the dApp can remove the secret s_0 from the link. As a result, the new link cannot be used by customers anymore. However, a new secret can be computed s_1=hash(s_0) and added to the link.

The dApp can perform the operations described above to form a proof P. In various implementations, the proof can be stored itself in the link, or the dApp can store the proof in a public location (e.g., an IPFS file, along with its address A and HI). This information can become public and identified with an IPFS address ipfs_1.

An example new link can look like:

2key.co/?c=<contract>&ipfs=<ipfs_1>&s=<s_1>

The Influencer can make this new link available to “downstream” customers and influencers. Notice that Influencer did not have any interaction with Ethereum.

Customer 2—‘Customer 2’ can be a user, entity, etc., that found the modified link as it was published by influencer 1. She opens the link and runs the dApp. The dApp's ‘BUY’ button/control takes s_1 from the link and reads the IPFS file content P_1,A_1,HI_1. The dApp then uses s_1, n=N−1=1 and its own address A_2 to compute HI_2 and P2. It then sends all this information (P_1,A_1,HI_1,P_2,A_2,HI_2) to the contract to complete the purchase.

Contract behavior for customer 2—the contract can call the verify library twice to check both P1 with public information A_1,HI_1,n=2,H and P_2 with public information A_2,HI_2, n=1,H.

The customer can thus prove or verify that she had access to the modified link secret s_1 and that it provided the influencer information that knew s_0. Then, the contract can allow the purchase to proceed/execute. A bounty can be allocated to the influencer (A_1.) This allocation can happen when ‘BUY’ is called or when the escrow is released.

Having a longer path—The maximal path N used above can be increased to another value to allow having paths with more influencers. For example N=3. In this case the contract will store H=hash(hash(hash(s_0))). A downstream influencer can take the modified link, create a proof that he knew the modified secret s_1 (with N−1) and stores it in ipfs_2 along with the proof of the first influencer or a reference to it using ipfs_1. And creates a new link:

2key.co/?c=<contract>&ipfs=<ipfs_2>&s=<s_2>

A customer using this downstream link creates a proof P_3 showing it knows s_2 (with N−2) and send it to the contract with P_2 and P_1. The contract validates P_1,P_2,P_3 and distribute the bounty between A_1 and A_2.

Optimization—in certain implementations, the zk solution above may requires the contract to verify each influencer in the path and the customer. Given substantial ‘gas’ costs, in certain implementations recursive SNARKs can be used to use a single proof verification for the entire path.

Example pseudocode described for the proof can be:

def verify(H,n,HIA, s):
assert(HI==hash(s+A)
assert(H==hash\hat{ }n(s))//apply hash n times
return 1

def hashN(x,N):

y1=hash(x)

y2=hash(y1)

y3=hash(y2)

y4=hash(y3)

y=y1

y=if N==2 then y2 else y fi

y=if N==3 then y3 else y fi

y=if N==4 then y4 else y fi

return y

The code can also supply the hash function. For example, using SHA256 from libsnark, it can accept two values so instead of performing hash(s+A), hash(s,A) can be performed. Also, instead of passing H,HI,A,s as (large) integers, a list of 256 bits can be passed for each.

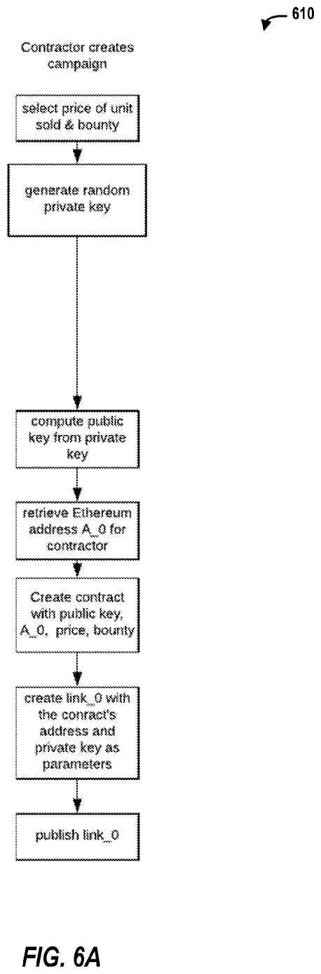

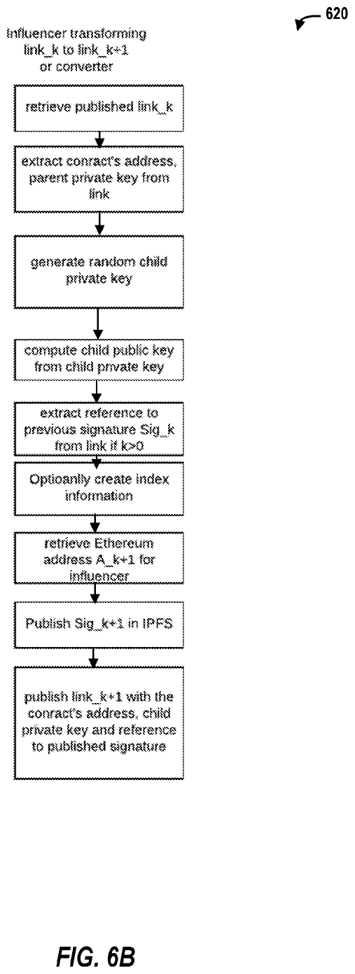

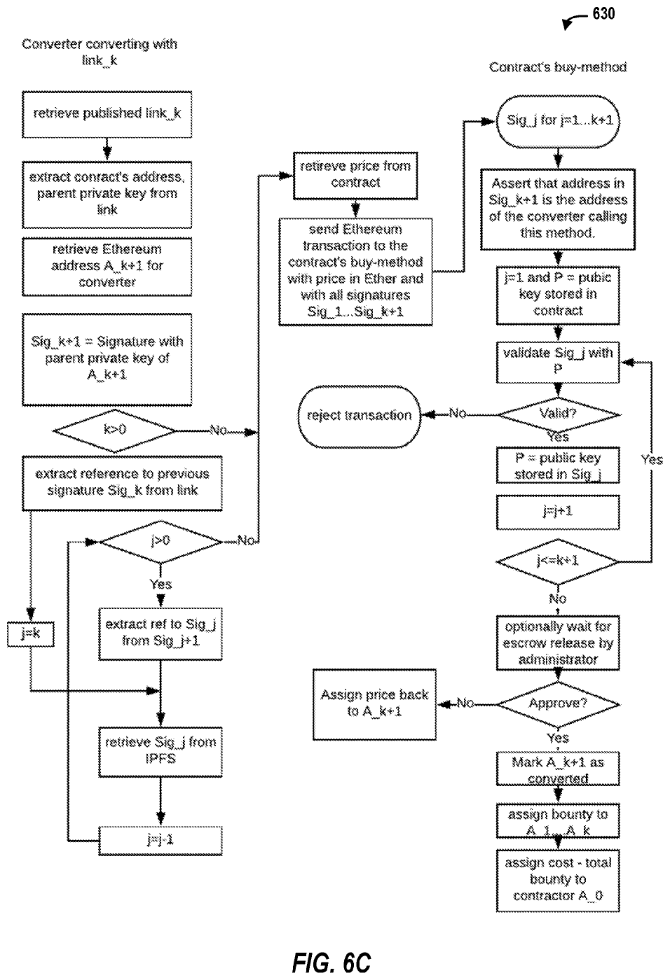

FIGS. 6A-6C depict further aspects of the described technologies, e.g., as implemented with respect to ‘Web 3.0’ technologies using Key Creation and/or Random Key Creation.—In such alternative implementations, a random private-public key pair can be used along the path from contractor to converter. Private keys can be passed through the links and public keys can be managed by the contract. For example, FIG. 6A depicts aspects of an example method 610 in which a random private key is generated and used to compute a public key. In doing so, a contractor can create a campaign, e.g., in a manner described herein.

In such an implementation, an influencer receives a secret from the contractor or an upstream influencer through the link. FIG. 6B depicts aspects of an example method 620 in which an influencer transforms a link (e.g., the link created in FIG. 6A), e.g., in a manner described herein. For example, as shown in FIG. 6B and described herein, the influencer creates a new link containing a proof that he knew the secret. In addition, the new link contains a new version of the secret that can be used by downstream influencers. The link can also keep the proofs of the upstream influencers. When a converter wants to convert (buy), she generates a proof that she knew the last secret and sends the proofs to a contract on Ethereum. The contract validates the proofs, extracts the address from the proofs, and distributes bounty.

As shown in FIG. 6B, the secret in this solution is a new random private key, different from the private keys used by the users to control their accounts. When a contractor creates a campaign, he also (with the help of his dApp) creates a new random private-public key pair (e.g., as shown in FIG. 6A and described herein). The public key is stored in the contract and the private key is added to the link. An alternative to randomly creating the new private key is to apply a hash function on the private key used by the contractor in Ethereum (or to use the private Ethereum key to sign a known message).

An influencer or converter exposed to a (parent) link can prove that he received, accessed, saw, etc. the link by using the parent private key found in the link.

An influencer can create a new random child private key and replace in the link the parent private key with the child. The influencer computes the public key for the new child private key. An alternative is to derive the child's private key from hash of influencer's Ethereum private key (or to use the private Ethereum key to sign a known message).

The influencer signs his address, the new child public key and optionally any additional information (called index). The referenced ‘additional information’ can include, for example, voting weight that each influencer and converter can add to the link. When a final conversion is made all weights can be tallied (e.g., to determine an outcome of a vote).

Moreover, in certain implementations the referenced additional information can include or reflect the amount of bounty requested or required by the influencer. Various other examples provided herein may assume that that the contract computes how much each influencer will receive (e.g., the bounty is divided equally between all influencers in the link). However, in certain scenarios the influencer can provide parameter(s) to the contract. For example, the influencer can specify what percentage from the maximal bounty it wants. In such a scenario, the leftover from the bounty can be passed to the influencers ‘downstream.’ By using this parameter, an influencer can decide and dictate how much he wants to motivate the downstream influencers.

As noted, the referenced ‘additional information’ can include a signature generated with the Ethereum private key of the influencer of the public address of the new secret and of any additional information such as the voting weight or bounty parameters. This signature proves that the influencer was indeed responsible to extend the link and to put the voting weight in it. It should be understood that such an (optional) signature is different from the signature which is done with the private key extracted from the link.

The signature can be generated with the parent private key extracted from the link. The influencer stores the signature in a public place. Alternatively, the signature can be stored directly in the link or the link can keep a short handle to a signature-file stored externally (IPFS) as described above.

FIG. 6C depicts aspects of an example method 630 in which a converter converts, executes a transaction, etc. via one of the described links (e.g., a link created in FIG. 6A and/or disseminated in FIG. 6B), e.g., in a manner described herein. As shown in FIG. 6C, in certain implementations a converter can sign his address using the parent private key.

When converting, a converter communicates to the “buy” method of a contract on Ethereum.

As shown in FIG. 6C and described herein, in certain implementations the converter supplies the signatures of influencers along the path from the contractor to her. A reference to the last influencer is available in the parent link she used. Her dApp extracts the contents of that signature (e.g., from IPFS) and from it retrieves the reference to the previous signature and so on. Alternatively, the signatures are retrieved directly from the link itself.

The contract validates the first signature in the path using the stored public key used by the contractor. The contract then extracts from the signature the public address of the next step and use it to validate the next signature and so on.

FIGS. 7A-7C depict further aspects of the described technologies, e.g., as implemented with respect to Hierarchical Deterministic Key Creation. In certain alternative implementations, Hierarchical Deterministic Key Creation (HD') techniques or technologies can be utilized. An example HD solution can be implemented, for example, as follows: Instead of creating a new random private-public child key pair (e.g., as described with respect to FIGS. 6A-6C), the influencer modifies the parent private key, thereby turning it into a new child private key.

In certain implementations, in each step of the path, the modification of the parent private key into a child private key can be one directional (such that the parent private key can't be derived from the child). For example, FIG. 7A depicts aspects of an example method 710 in which a contractor creates such a campaign. FIG. 7B depicts aspects of an example method 720 in which an influencer transforms a link (e.g., the link created in FIG. 7A), e.g., in a manner described herein. FIG. 7C depicts aspects of an example method 730 in which a converter converts, executes a transaction, etc. via one of the described links (e.g., a link created in FIG. 7A and/or disseminated in FIG. 7B), e.g., in a manner described herein. In one implementation, the child private key can be a hash of the parent private key. In another implementation, the secret passed in the link can be a pair of private-key and chain-code (e.g., as is done in BIPS32). In each step the chain code can be hashed and added to the parent private key to form the child private key and a different hash of the chain code can be used to form a child chain code.

In certain implementations, it may not be advantageous to enable an influencer to be able to retrieve the parent private key from the child private key given to it in the link. It may also not be advantageous to let him know the parent chain-code (if used). As a result, in certain implementations it may not be advantageous to store the contractor's chain-code in the contract (and therefore the contract cannot re-create by itself the list of public keys used). However, in the current implementation, the chain of keys can be deterministically known the moment the campaign was created. This allows for several alternative approaches:

For example, possible public keys can be computed in advance and loaded to the contract by the contractor at the time of contract creation. When converting, the contract validates signature(s) by retrieving the stored public key. This puts a limit on the maximal path length.

By way of further example, the contract keeps a conversion in an escrow. The contract releases the conversion when the contractor supplies the missing public keys needed to validate the conversion.

By way of further example (in line with the example provided above), each influencer can compute the public key for the child and sign the new public key in addition to signing his own address using the parent private key. The converter supplies the signatures and the contract validates the first signature in the path using the stored public key used by the contractor. The contract then extracts from the signature the public address of the next step and uses it to validate the next signature and so on.

In certain implementations, the path of public/private keys can be turned into a hierarchy of keys. Each parent key can branch out to many child keys, each having a different index. Influencers can decide on an index and add the index value to the child creation process. The influencer can publish what index he used, e.g., by placing the index in the signature. If the first option of loading all public keys is used then the contract can store the tree of public keys when the contract is created.

In certain implementations, the signature done in every step can be repeated using the private key used by the user (contractor, influencer or converter) to interact with Ethereum. This signature proves that the user was the person who created the first signature that is based on the secret passed in the link. The converter can pass the additional signatures to the contract and the contract can validate the additional signatures and only then allow the purchase to happen.

As noted, in various scenarios described above, the assumption was that a link is written at the time the contract in the main chain by the converter who pays for all the ‘gas’ needed. However, in certain implementations a link can be written to the contract by an influencer (not by a converter). In such a scenario, the influencer pays the gas. The influencer may be motivated to do so in order to secure his title as an influencer by receiving an ARC token on the main blockchain. As noted above, once an influencer has an ARC he can start his own link.

Additionally, in certain implementations the described technologies can be configured to collect a number of links ‘off-chain’ (e.g., in a side-chain). Such collected links can then be transferred to the contract on the main chain as single “conversion” events. In such a scenario, the entity that is doing the mass transfer (e.g. the contractor) pays for the gas. Additionally, in certain implementations the described technologies can identify overlapping segments between the different links and send such overlapping parts only once (in order to save on this gas).

By way of further illustration, it can be appreciated that various batch transfer operations may be advantageous since sending data in a transaction costs gas (e.g., 68 per non-zero byte), which can become significant when sending many messages together in one transaction (e.g., in voting). This puts a limit on data size in one transaction or the number of links that can be sent in one transaction, (because the maximal gas you can spend in a block is limited to about 8M (8,000,029−21,000)/68=approximately 117,338 non-zero bytes)—or about 50 full URL links (corresponding to about 500 different influencers, as described in detail herein). In practice, many users may use the same link of an influencer/contractor and all these users can be grouped together so these 500 influencers may cover much more than just 50 conversions.

In another implementation, the described technologies can be further configured to transfer the address of each influencer (and additional information it sent, e.g., weight) while removing/editing out other information (e.g., which proves the influencer is part of the link and is who he is). These collected proofs can then be sent as a single zk proof to the contract (enabling the contract to accept all the information about the influencers in a single zk proof). Doing so can be advantageous, e.g., to save on gas associated with the transfer of multiple transactions corresponding to the respective influencers reflected in a link.

Additionally, in certain implementations the described technologies can be configured with respect to voting. As noted above, in such scenarios each influencer can add his own voting weight to the link. When such a link is written in the contract, the voting weight of each influencer is recorded in the contract (e.g., on the main chain).

In certain scenarios a single influencer may use different voting weights in different links. In this case the contract can be configured to decide which weight value to use (e.g., the first weight seen) or to reject influencer vote completely if such weights are inconsistent

In certain scenarios it may be advantageous to define or limit how much weight each influencer can place in a vote. A simple example is a yes/no vote and the weight of each influencer is ‘1.’ However, in certain scenarios it may be advantageous or necessary to limit who is allowed to vote at all. For example, other voting scenarios may involve several options to choose from and configured to allow a voter to select multiple options and allocate or ascribe different weights (e.g., a number 1-100) to each option. In such a scenario it may be advantageous or necessary to limit the total weight an influencer can allocated, thereby preventing such influencers from ‘abusing’ the system. To do so, in certain implementations a special voting coin or token can be allocated or distributed to each eligible influencer (e.g., in advance). Such an influencer can then ascribe a weight to a particular voting option by spending some or all of these voting coins.

It may also be advantageous to incentivize such influencers by providing a bounty (e.g., additional voting coins) for an influencer who brings more voters. In doing so, influencers that recruit more voters can allocate more weight in the referenced vote.

As noted above, in certain implementations the described technologies can be configured such that links can be written to the contract by influencers and/or collected and written in bulk (e.g., to save on ‘gas’).

In certain implementations, the referenced voting contract can include parameter(s) that define when the contract completes/expires (e.g., at a defined cut-off date/time, at a certain number of votes reached, etc.). The contract then executes by tallying the total vote made by all influencers and completes any corresponding transfers/transactions.

It should be understood that the links referenced above and described herein can be a certificate chain in which each influencer receives the private key of the previous influencer and uses it to sign his own certificate. Such links can be defined, structured, or otherwise configured in various ways. For example, in certain implementations such a link can be a URL-path that defines where the dApp should be loaded by the browser.

In certain implementations, the referenced link can include parameters such as: (1) the address of the campaign contract (e.g., in Ethereum blockchain) (“c”), (2) the address (e.g., eth address) of the last user in the chain of influencers (“f_address”), (3) the secret of the last user (known to anyone seeing the link but not stored on the blockchain) (“f_secret”), and (4) a message containing content such as previous users in the chain of influencers, the public part of their secret, and a cryptographic proof that each influencer saw the secret of the previous influencer in the chain (“p_message”).

In certain implementations, such links can be generated and/or utilized such that each user provides a proof that he ‘saw’ or had access to the secret of the previous user in the link (e.g., the previous influencer/contractor). Each user also adds 1 byte of personal information (referred to herein as “cut”). In other implementations, the user can additionally generate/provide a proof that he actually was the user that gave the proof referenced above (e.g., that he ‘saw’ or had access to the secret of the previous user in the link).

As noted, “f_address” can be an eth address of the last user in the chain of influencers. The user can provide this information to the link in its current form. When the contract is first created first, this address will correspond to the contractor. As the link is disseminated/shared between influencers, this address will correspond to the last influencer to modify the link. In certain implementations, such an address may, for example, take up 20 bytes within the link (e.g., written as 40 hexadecimal numbers).

“f_secret” can correspond to the secret of the last user/influencer. Such a secret may, for example, take up 32 bytes within the link. This can be the secret which is known to anyone seeing the link but not stored on the blockchain. Users can compute the public part of this secret (“f_public”) internally (which may take up 20 bytes).

As noted, “p_message” can be a field or segment that contains or reflects elements such as: previous users in the chain of influencers, the public part of their secret, any of their personal parameters such as “cut” and a cryptographic proof that each influencer saw/had access to the secret of the previous influencer in the chain.

When a link is first created the “p_message” field/segment can be empty. This is because the public key for the “f_secret” of the user who created the link (e.g., the contractor) is already stored in the contract. Only the contractor or influencers that are already stored on the blockchain can create a link (so there is little need for them to prove anything). Additionally, the contractor may not need to have a “cut” or if the link is created by an influencer that is already on the blockchain then his “cut” should also be already stored on the blockchain.

In order to join the described chain, a user can receive or otherwise access a link (e.g., originating from a contractor/influencer). Such an accessing user creates his own new “f_address”, new “f_secret” and computes for it a new “f_public.” The user then creates a new “p_message.”

By way of further illustration, when a user receives a link with an empty old “p_message” field, he creates a new “p_message.” Such a new “p_message” field can be generated by first placing the “version” of the link (e.g., 1 byte which can be a 0 or 1) and the old “f_address.” If “p_message” is not empty the user, in certain implementations, adds the old “f_address.” The user also adds the old “f_public”.

The user then adds (to the referenced new “p_message”) a signature (“sign”) (which may take up, for example, 65 bytes) and his new “cut” (1 byte). In certain implementations, such a signature (“sign”) can be computed with the old “f_secret” of the SHA3 hash of the concatenation of various fields/segments, such as the new “cut”, new “f_public” and/or new “f_address.” Alternatively, in lieu of adding a new signature for each new influencer in the link, in certain implementations the described technologies can be configured to generate a single aggregated signature (e.g., which accumulates in it all the signatures across the chain), as described in detail below.

In certain implementations, the user can then add a second signature (which may take up to 65 bytes) (a new “cut_sign”). Such a signature can be computed with the new “f_address” of a SHA3 hash of concatenation of SHA3 hash of the concatenation of the strings “bytes binding to weight” and “bytes binding to public” and/or an SHA3 hash of the concatenation of “cut” and new “f_public. As noted, such a signature can serve as proof that such a user actually was the user that gave the referenced proof

As noted, in lieu of adding a new signature for each new influencer in the link (as described above), in certain implementations the described technologies can be configured to generate a single aggregated signature (e.g., which accumulates in it all the signatures across the chain) (e.g., a ‘BGLS’ (Boneh, Gentry, Lynn, Shacham) signature). In certain implementations, such a scheme can replace the “sign” (65 bytes) added to the link by each influencer, as described in detail above. For example, instead of adding a new “sign,” each influencer replaces the previous “sign” with his own new “sign” which includes, in it, all the previous “sign” contained in/reflected by the link.

By way of further illustration, to enable the described aggregated signature, each influencer creates a secret (“f_secret”) and publishes its public key (as “f_public”). The SHA3 hash of the concatenation of new “cut”, new “f_public” and new “f_address” (“h”) can then be computed, as described above. The “sign” as computed up to now (e.g., as received from the previous influencer) can be multiplied with “h\hat{ }x” to generate a new “sign” (note that the contractor/first-influencer can just assign “sign” to his “h\hat{ }x”).

The new “sign” generated in the described manner is 64 bytes long (two 256 bit integers) and may need to appear only once in the link. However, the referenced “f_public” segment may still need to appear for each influencer in the link (and may now be 33 bytes long since we need its full value, not just its hash which is 20 bytes). In other implementation each signature is 65 bytes long (compared to the address of “f_public” which is a hash of the full key). Accordingly, using the described techniques, 52 bytes can be saved (65+20−33) as compared to the techniques described above (in which a new “sign” is added for each influencer in the link). It should be understood that, in certain implementations, this scheme does not include the additional signature (“cut_sign”) referenced above.

It should be noted that when performing batch transfer operations (as described above), it can be possible to multiply signatures from different paths when combined into one transfer.

In yet other implementations, in lieu of adding a new signature for each new influencer in the link (as described above), Schnorr signatures can be used (e.g., as an alternative to the described implementation using aggregated BGLS signatures). In such an implementation, the link works as described herein and an “f_secret” (referred to as ‘x’ below) and “f_public” which is 64 bytes (referred to as ‘P’ below) which can be calculated on an elliptical curve with generator point G:P=x*G

It can be appreciated that, with respect to the above formula, determining x given P is a hard problem.

Accordingly, in the present implementation of the described link, a Schnorr signature can be utilized. To do so, a random private key ‘r’ and its public part ‘R’:R=r*G is generated.

A hash of the message to be signed is computed. In the present example, the message can be referenced as ‘P’ concatenated with the Ethereum address of the user ‘A’:

e=Hash(P∥A)

The signature (‘σ’) can be computed:

σ=r+e*x

Validation is made by receiving the signature (‘σ’) multiplying it by G and comparing to R+e*P:

σ*G=(r+e*x)*G=r*G+e*x*G=R+e*P

In certain implementations, various modifications to the referenced techniques can be made. For example, consider a scenario in which influencer number n wants to add his information to the link he received from influencer n−1. In certain implementations, the described technologies can be configured such that this new influencer randomly creates a new random xₙ,rₙ, computes its Pₙ,Rₙ and hash eₙ=Hash(Pₙ∥Aₙ). Accordingly, the signature is now σₙ=rₙ+eₙ*xₙ₋₁ (using xₙ₋₁, received in the link from the previous influencer). Instead of concatenating Rₙ and σₙ to the link (as described elsewhere herein), they can be added to the previous values:

R⇐R+Rₙ and σ⇐σ+σₙ

As noted, the influencer needs to replace the secret of the link with his private key xₙ. As described herein, the influencer can concatenate his public key Pₙ and his address A. The contractor/link-creator starts with a secret x₀ and a public key P₀ which is stored in the contract and R=0,σ=0.

The link can be validated by computing the eᵢ=Hash(P₀∥ . . . ∥Pᵢ∥Aᵢ) and adding Pₑ=Σᵢ₌₁ⁿ eᵢ*Pᵢ₋₁ and comparing σ*G=R+Pₑ

Each influencer can add 33 bytes for P and 20 bytes for A to the link (which is 52 bytes better than before).

Note that as before, the influencer cannot reuse the pair x, P anywhere else because x was published.

As noted above, when a user wants to use a link to enable him to take a particular action in the campaign contract (e.g., to convert), he creates a new “p_message,” e.g., in the manner described above (e.g., using the “version” of the link, the old “f_address,” and the old “f_public,” as described in detail above). Such a new “p_message” is then sent to a method in the campaign contract (e.g., “transferSig”). Such a method then validates the link and reads the information contained within it (e.g., using an Ethereum library method). It should be noted that one problem with aggregated Schnorr signatures is that the last user can insert a ‘poisonous’ public key that cancels out the public keys contributed by previous users. However, in the described scheme this is not possible because each public key is later multiplied by the next hash which is not known in advance. The converter performs the last signature computation using his Pᵢ and eᵢ however he does not have a place to use his secret xᵢ.

As noted, in certain implementations the described link can be stored directly in the URL (and not in IPFS). Doing so may limit the size of the URL (e.g., to 2,000 characters). In certain implementations, each step in a chain entails adding the “f_address,” “f_public,” “cut,” signature with “f_secret” and (optionally) signature with “f_address.” Accordingly, storing such a link directly in the URL may limit the number of influencers that can be stored in a chain (e.g., 6 influencers in a URL in which the signature with “f_address” is included, 9 influencers in a URL in which the signature with “f_address” is not included. It should be understood that the referenced estimates assume use of hexadecimal encoding, and utilizing, for example, base64 encoding can further reduce the number of URL characters for each influencer to enable 10 or more influencers in a single URL.

The “p_message” of the referenced link can be sent to the “transferSig” method in a contract using an Ethereum transaction.

It should also be noted that, in certain implementations, the described technologies can enable various access control functions. For example, a list of users that can act as influencers and/or converters can be defined in advance. By way of illustration, a contractor can dictate that only people in his mailing list can act as influencers.

It can therefore be appreciated that the described technologies are directed to and address specific technical challenges and longstanding deficiencies in multiple technical areas, including but not limited to referral tracking, artificial intelligence, and distributed computing. As described in detail herein, the disclosed technologies provide specific, technical solutions to the referenced technical challenges and unmet needs in the referenced technical fields and provide numerous advantages and improvements upon conventional approaches. Additionally, in various implementations one or more of the hardware elements, components, etc., referenced herein operate to enable, improve, and/or enhance the described technologies, such as in a manner described herein.

As used herein, the term “configured” encompasses its plain and ordinary meaning. In one example, a machine is configured to carry out a method by having software code for that method stored in a memory that is accessible to the processor(s) of the machine. The processor(s) access the memory to implement the method. In another example, the instructions for carrying out the method are hard-wired into the processor(s). In yet another example, a portion of the instructions are hard-wired, and a portion of the instructions are stored as software code in the memory.

Further aspects and implementations of the described technologies are provided below.

Existing referral-tracking technologies rely heavily on tracking pixels for marketing-attributions and conversion tracking. Such pixels require complex integrations and ongoing management by site/app owners. Additionally, such pixels often have no visibility outside the websites/apps in which they're installed. Additionally, information that is tracked using such pixels by separate competing website/app owners is often segregated (such that information tracked by one service may be unavailable to another service).

Accordingly, described herein in various implementations are technologies that enable pixel-less referral tracking and other related technologies. As described in detail herein, the disclosed technologies can migrate the Internet's tracking from siloed pixel integrations within business websites or apps into the tracking links themselves. For example, the described technologies enable the tracking itself to be performed by the links being shared. Doing so can provide a full attribution model, where multi-step referrals and conversions are tracked by the passing of web3.0 tokens between participants. This produces a closed loop blockchain-based technology which enables businesses to open conversion contracts, and have these shared seamlessly online, tracking the full referral chains, and rewarding/reimbursing those who helped effectively spread the word (i.e. market the business's offering) upon successful conversions.

As described in detail herein, a contract (e.g., a ‘smart contract’) can be generated by an interested party. Such a contract can define a desired result and the reward offered for anyone who enables the achievement of that result via sharing the contract. A decentralized or distributed (e.g., blockchain) computing infrastructure can provide a platform for such a contract to be maintained, disseminated, and/or executed.

To provide universal functionality, the referenced contract can include a link that provides a web 2.0 interface for the contract Such a link can correspond to a web page that can be used to interface with the contract (e.g., to sign on as influencer, or fulfill the contract as converter, as described herein).

The referenced contract (and/or corresponding link) can then be disseminated to other participants, users, entities, etc., in any number of ways. Users can interface with the contract via web2.0 and/or web3.0 interfaces. Such receiving users can further disseminate the contract/link until a conversion event occurs (e.g., fulfilling the contract's required action(s), as described herein). The relays from influencer to influencer can serve as a form of rev-share transactions, with each party participating as an influencer ultimately earning money, credit, rewards, etc., as well as reputation for helping to relay the contract until the contract is fulfilled.

An example environment is depicted in FIG. 1. As shown in FIG. 1, the described technologies (including systems, methods, services, platforms, etc., such as those described/referenced herein) can be implemented in conjunction with various devices, components, elements, etc. For example, an example platform can include or otherwise interface with a decentralized or distributed leger such as a blockchain (e.g., Ethereum, as shown in FIG. 1) that can be distributed/stored across multiple connected nodes. Examples of such nodes are depicted in FIG. 1 and described herein.

The referenced nodes can be computing devices, storage device, and/or any other such connected device or component configured to generate and/or provide verification (e.g., for a transaction, operation, etc.). Various nodes can be connected to one another (directly or indirectly) via various network connections, thereby forming a distributed computing environment or network.

In an example transaction, ownership of a digital token can be transferred from one address to another. To authenticate the transaction, the transaction recording the transfer can be signed by the originating party using a private key associated with that originating party (e.g., as stored on a device or wallet, such as “wallet” as shown in FIG. 1). Such a private key can be a cryptographic key (e.g., a string of bits used by a cryptographic algorithm to transform plain text into cipher text or vice versa) that may be kept secret by a party and used to sign transactions (e.g., the transfer of a token to another user, to a server, etc.) such that they may be verified using the described distributed computing environment.

The referenced signed transaction can then be broadcast across the distributed computing environment/network, where it can be verified, e.g., using the public key associated with the originating party. Such a “public key” can be a cryptographic key that is distributed to, or available to the referenced node(s) so that signed transactions associated with the public key may be verified by the nodes.

During the referenced verification process, the transaction can be accessed or selected by a consensus node (e.g., a device or ‘miner’ configured to verify transactions and add new blocks to a blockchain), verified using the public key, timestamped, and added to a “block” that includes other transaction(s). To perform the referenced verification the consensus node can, for example, solve a cryptographic puzzle, e.g., to identify a nonce value that, when used with a hash function, results in a value formatted in a specific way. Upon solving the puzzle, the consensus node creates a proof of work that is then verified and (if the solution is valid) added to the blockchain ledger.

Adding completed blocks to the blockchain ledger forms a permanent public record of various included transactions. The blockchain ledger can be replicated and distributed across multiple nodes within the distributed environment. In the event that a user tries to utilize a previously transferred digital token, the first transaction conducted using the token address may promulgate to remote nodes faster than any subsequently conducted transaction using the same token address. This allows more time for additional blocks to be added to the blockchain that include the first transaction. In this scenario, a node that receives two separate chains that include blocks with transactions originating from the same token address will choose the longest chain, which should be associated with the first conducted transaction. In such a manner, the blockchain may be used to provide verification of various operations, transactions, etc.

Further aspects of the technologies depicted in FIG. 1 are described in detail below.

Sharing links online (e.g., hyperlinks) to products services and content, creates economic value. When we share online and people follow our links, we create gains for the sellers of the products, services or content we help to distribute. Yet the existing linking/referral technical infrastructure does not appropriately credit or reward users/parties who fuel growth/dissemination.

As described herein, the disclosed technologies enable users/entities to be seamlessly rewarded as part of their native online experience. In certain implementations, such rewards can be computed in relation to the economic value generated by various acts of sharing.

Among the disclosed technologies are various links referred to herein as “Action Referral Coin(s)” (ARC). As described herein, such links can enable benefits to both sides of the share. Doing so can enable a seamless sharing economy, so that the act of sharing links anywhere online can generate credits, rewards, etc. for those who share.

Also included in the disclosed technologies is a platform or technical infrastructure. Such platform/infrastructure may be referred to herein as a Global Referral Network (“GRN” or “RefNet”). In certain implementations, such a platform can be a peer-to-peer platform that enables businesses, freelancers, publishers and others to seamlessly mobilize the human web to produce results of value (e.g., bringing in new customers). The described technologies can, for example, enable one participant to define a required result and incentivize others/the web to efficiently pursue the result Contractors (that is, participants, users, etc., that define or initiate the contracts described below) can, for example, set a reward/price and pay only per result. Additionally, as described herein, rewards for spreading the word and fulfilling the contracts can be offered via dynamic reputation and performance driven incentive models. In doing so, referral chains can be optimized to target an audience which can effectively produce the result

The described technologies can also enable ‘Social-Sourcing’—e.g., incentivized activation of result-driven organic virality.

For example, the described technologies can enable an interested party to offer credits/rewards to the masses for helping to produce a defined result (thus utilizing the power of targeted organic virality). In certain implementations, such an offer can be defined in a contract (e.g., a ‘smart contract’) within the referenced platform. Such a contract can, for example, offer or define various incentive(s) for helping distribute the contract and/or fulfilling its terms. In doing so, the public can be rewarded for helping to produce a result valued by the contractor. The public's contribution in this regard can be leveraging individual contacts, social networks, etc. to organically distribute/disseminate the contract (e.g., towards an audience that is willing and able to convert the contract). Further aspects of the referenced contract(s) are described herein.

In certain implementations, the described technologies can distribute digital tokens (e.g., influence tokens), e.g., as currency, compensation, rewards, etc. for referral(s). In certain implementations, such tokens can also be used to purchase goods and services (e.g., those offered via the referenced contracts). Such tokens can be liquid and tradable yet can also be engineered/configured to be governed by an economy AI which may be optimized for market cap and flow (as described herein). Doing so can create a synergistic effect where network/platform participants can be incentivized to activate new contracts and tokens, and then to keep the tokens flowing within the platform/economy (since they're in effect receiving rewards embedded into a savings account which can be most useful when used back to purchase goods and services within predefined timeframes).

In the described platform (one example implementation of which is depicted in FIG. 1), the contractor can determine the value of the action requested from the public to produce. Additionally, in the described platform the contractor pays for the work, and the public performs it.

In certain implementations, the described technologies (including the referenced Global Referral Network) can operate as a general distributed social contracting platform for the web.

The described technologies further incorporate referral solutions/techniques that implement various distributed/decentralized computing technologies (e.g., blockchain) and artificial intelligence (“AI”) techniques (which may incorporate game theory and other techniques). The described solutions can be usable by anyone and do not require users to implement any special software or code.

Existing referral marketing technologies can be effective for large enterprises but are often out of reach for small businesses/individuals. By integrating technologies such as blockchain, smart contracts, etc., the described technologies can provide a new global platform/economy based on link sharing. As described herein, the disclosed technologies enable a mass-scale decentralized link-sharing economy via an incentive model for online sharing.

As noted, the described technologies enable Social-Sourcing, the incentivized activation of result-driven organic virality. Doing so can, for example, enable the optimized search for a target audience that is able and interested in producing a desired result.

Using the described technologies, a user/participant can, for example, define a required result and incentivize a network/web of participants to pursue the target audience needed to obtain that result Example users of this incentivized organic distribution can include freelancers seeking new clients, small businesses looking to expand their client bases, police stations searching for suspects, schools recruiting new students, publishers looking to expand their core audience, and pharmaceutical companies gathering data on drug side effects from patients. The described technologies provide solutions when crowdsourcing the organic web is needed to obtain a desired result.

In certain scenarios, the described technologies can include or involve participants, entities, etc. such as:

Contractors—e.g., the interested party issuing the contract who offers a reward for each required result obtained.

Influencers—e.g., the ones sharing the contract and being rewarded if their sharing resulted in its fulfillment.

Converters—The ones ultimately acting out the desired result of the contract (signing up for a service, paying for a product, consuming content, providing information, etc.).

The described platform, which acts as the trustee in the contract. In such a role, the platform can, for example, ensure transactions, uphold dispute resolutions and abuse prevention, monitor and persist reputation of the various players and enable reputation-based dynamic incentive models for optimized network activation. Infrastructure-wise, the described platform can moderate the contract transaction fees for web3.0 users or enables them altogether for web2.0 interfaces. The described platform can also maintain a web application and mobile apps that enable contract generation and advanced contract analytics amongst other functionality, as well as Web2.0 interfaces for the contracts and players in the network.

The described platform can further include or utilize tracking technologies integrated into the described ARC. Such technologies can include a decentralized or distributed (e.g., blockchain) computing infrastructure allowing for links that play out smart-contracts and perform self-tracking and management as they are distributed online. ARCs allow complex, multi-step, multi-party, state syncing and conversion events, as well as continuous real-time access to a blockchain-synced state, thereby enabling continuous dynamic monitoring, moderation and analytics of the smart contract network of operation, available per user-role permissions in the contract.

The described technologies also include a multi-party state-network solution for scalable decentralized multi-step referral tracking for a Web2.0 experience using Web2.0 links and users' browsers, while still being synced to the Ethereum blockchain to govern the underlying smart contract and to ensure security, fairness, fraud-prevention, and contract-adherence.

As noted, the described technologies can integrate various predictive models that employ game theory and machine learning to dynamically optimize incentive models based on the a-priori and intra-contract reputations of the various players. For example, the described reputation-based algo-bidding and AI-based dynamic incentive models can optimize the return on investment for participants in the network.

Sign-Ins and Wallets—The described interfaces can require users to be registered within the disclosed platform as well as to have a viable web3 account to properly attribute and serve their participation in the referral network. For registration (sign-up/sign-in) various user experiences can be supported to support maximum seamlessness—explicit sign-up/in, and implicit sign-up/in. In terms of web3 accounts, the described platform can either manage a web3 wallet for the user (i.e. hold on to the private keys and let the user access balances via their platform sign-in), or enable the user to hold on to the private keys themselves (while still having the platform to facilitate the interface to the wallet itself), or enable the user to work with their own wallet (e.g., MetaMask, or any other web3 ERC20 compliant client). The disclosed architecture mixes and matches between the sign-up/in and wallet interface options to achieve optimal seamlessness for any point in time, to optimize for mass-scale usability.

It should also be noted that while the technologies described herein are illustrated primarily with respect to a decentralized protocol for maintaining cryptographically proven multi-party state networks, the described technologies can also be implemented in any number of additional or alternative settings or contexts and towards any number of additional objectives. It should be understood that further technical advantages, solutions, and/or improvements (beyond those described and/or referenced herein) can be enabled as a result of such implementations.

Certain implementations are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example implementations, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some implementations, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module can also include programmable logic or circuitry that is temporarily configured by software to perform certain operations. For example, a hardware module can include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering implementations in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor can be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In implementations in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API).

The performance of certain of the operations can be distributed among the processors, not only residing within a single machine, but deployed across a number of machines. In some example implementations, the processors or processor-implemented modules can be located in a single geographic location (e.g., within a home environment, an office environment, or a server farm). In other example implementations, the processors or processor-implemented modules can be distributed across a number of geographic locations.

The modules, methods, applications, and so forth described herein are implemented in some implementations in the context of a machine and an associated software architecture. The sections below describe representative software architecture(s) and machine (e.g., hardware) architecture(s) that are suitable for use with the disclosed implementations.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture can yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

FIG. 8 is a block diagram illustrating components of a machine 800, according to some example implementations, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein can be executed. The instructions 816 transform the general, non-programmed machine into a particular machine programmed to carry out the described and illustrated functions in the manner described. In alternative implementations, the machine 800 operates as a standalone device or can be coupled (e.g., networked) to other machines. In a networked deployment, the machine 800 can operate in the capacity of a server machine or a client machine in a server-client network environment, or as a peer machine in a peer-to-peer (or distributed) network environment. The machine 800 can comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 can include processors 810, memory/storage 830, and I/O components 850, which can be configured to communicate with each other such as via a bus 802. In an example implementation, the processors 810 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) can include, for example, a processor 812 and a processor 814 that can execute the instructions 816. The term “processor” is intended to include multi-core processors that can comprise two or more independent processors (sometimes referred to as “cores”) that can execute instructions contemporaneously. Although FIG. 8 shows multiple processors 810, the machine 800 can include a single processor with a single core, a single processor with multiple cores (e.g., a multi-core processor), multiple processors with a single core, multiple processors with multiples cores, or any combination thereof.

The memory/storage 830 can include a memory 832, such as a main memory, or other memory storage, and a storage unit 836, both accessible to the processors 810 such as via the bus 802. The storage unit 836 and memory 832 store the instructions 816 embodying any one or more of the methodologies or functions described herein. The instructions 816 can also reside, completely or partially, within the memory 832, within the storage unit 836, within at least one of the processors 810 (e.g., within the processor's cache memory), or any suitable combination thereof, during execution thereof by the machine 800. Accordingly, the memory 832, the storage unit 836, and the memory of the processors 810 are examples of machine-readable media.

As used herein, “machine-readable medium” means a device able to store instructions (e.g., instructions 816) and data temporarily or permanently and can include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 816. The term “machine-readable medium” shall also be taken to include any medium, or combination of multiple media, that is capable of storing instructions (e.g., instructions 816) for execution by a machine (e.g., machine 800), such that the instructions, when executed by one or more processors of the machine (e.g., processors 810), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 850 can include a wide variety of components to receive input, provide output, produce output, transmit information, exchange information, capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 can include many other components that are not shown in FIG. 8. The I/O components 850 are grouped according to functionality merely for simplifying the following discussion and the grouping is in no way limiting. In various example implementations, the I/O components 850 can include output components 852 and input components 854. The output components 852 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), visual input components (e.g., a camera, such as may be configured to capture and/or detected image(s) of QR codes and/or other content) and the like.

In further example implementations, the I/O components 850 can include biometric components 856, motion components 858, environmental components 860, or position components 862, among a wide array of other components. For example, the biometric components 856 can include components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram based identification), and the like. The motion components 858 can include acceleration sensor components (e.g., accelerometer), gravitation sensor components, rotation sensor components (e.g., gyroscope), and so forth. The environmental components 860 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that can provide indications, measurements, or signals corresponding to a surrounding physical environment. The position components 862 can include location sensor components (e.g., a Global Position System (GPS) receiver component), altitude sensor components (e.g., altimeters or barometers that detect air pressure from which altitude can be derived), orientation sensor components (e.g., magnetometers), and the like.

Communication can be implemented using a wide variety of technologies. The I/O components 850 can include communication components 864 operable to couple the machine 800 to a network 880 or devices 870 via a coupling 882 and a coupling 872, respectively. For example, the communication components 864 can include a network interface component or other suitable device to interface with the network 880. In further examples, the communication components 864 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 can be another machine or any of a wide variety of peripheral devices (e.g., a peripheral device coupled via a USB).

Moreover, the communication components 864 can detect identifiers or include components operable to detect identifiers. For example, the communication components 864 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information can be derived via the communication components 864, such as location via Internet Protocol (IP) geolocation, location via Wi-Fi® signal triangulation, location via detecting an NFC beacon signal that can indicate a particular location, and so forth.

In various example implementations, one or more portions of the network 880 can be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 880 or a portion of the network 880 can include a wireless or cellular network and the coupling 882 can be a Code Division Multiple Access (CDMA) connection, a Global System for Mobile communications (GSM) connection, or another type of cellular or wireless coupling. In this example, the coupling 882 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 8G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 816 can be transmitted or received over the network 880 using a transmission medium via a network interface device (e.g., a network interface component included in the communication components 864) and utilizing any one of a number of well-known transfer protocols (e.g., HTTP). Similarly, the instructions 816 can be transmitted or received using a transmission medium via the coupling 872 (e.g., a peer-to-peer coupling) to the devices 870. The term “transmission medium” shall be taken to include any intangible medium that is capable of storing, encoding, or carrying the instructions 816 for execution by the machine 800, and includes digital or analog communications signals or other intangible media to facilitate communication of such software.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component Similarly, structures and functionality presented as a single component can be implemented as separate components. These and other variations, modifications, additions, and improvements fall within the scope of the subject matter herein.

Although an overview of the inventive subject matter has been described with reference to specific example implementations, various modifications and changes can be made to these implementations without departing from the broader scope of implementations of the present disclosure. Such implementations of the inventive subject matter can be referred to herein, individually or collectively, by the term “invention” merely for convenience and without intending to voluntarily limit the scope of this application to any single disclosure or inventive concept if more than one is, in fact, disclosed.

The implementations illustrated herein are described in sufficient detail to enable those skilled in the art to practice the teachings disclosed. Other implementations can be used and derived therefrom, such that structural and logical substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

What is claimed is:

1. A system comprising:
a processing device; and
a memory coupled to the processing device and storing instructions that, when executed by the processing device, cause the system to perform one or more operations comprising:
receiving a first link, the first link comprising a first private key generated with respect to a first user;
generating, with respect to a second user, a second private key;
computing, using the second private key, a cryptographic signature of the first private key; and
generating a second link comprising the second private key, the cryptographic signature of the first private key, and one or more public keys.

2. The system of claim 1, wherein the memory further stores instructions for causing the system to perform operations comprising disseminating the second link.

3. The system of claim 1, wherein the first user s associated with a first address.

4. The system of claim 1, wherein the one or more public keys comprises a public key corresponding to the first private key.

5. The system of claim 1, herein the memory further stores instructions for causing the system to perform operations comprising:
generating, with respect to a third user, a third private key;
computing, using the third private key, a cryptographic signature of the second private key; and
generating a third link comprising the third private key, the cryptographic signature of the second private key, and one or more public keys comprising a public key corresponding to the first private key and a public key corresponding to the second private key.

6. The system of claim 5, wherein the cryptographic signature of the second private key comprises an aggregated cryptographic signature.

7. The system of claim 5, wherein the cryptographic signature of the second private key comprises a Schnorr signature.

8. The system of claim 1, wherein the second link further comprises one or more parameters.

9. The system of claim 8, wherein the one or more parameters comprise at least one of: one or more parameters that define one or more aspects of a subsequent dissemination of the second link, a contract address, an identifier associated with the second user, or a weight assigned by the second user.

10. The system of claim 8, wherein the one or more parameters comprise at least one of: one or more parameters provided by the first user within the first link.

11. The system of claim 8, wherein the one or more parameters comprise one or more parameters associated with the second user.

12. The system of claim 1, wherein generating a second link further comprises substituting, within the second link, an integer for the one or more public keys.

13. The system of claim 1, wherein generating a second link further comprises shortening the second link via an external service.

14. The system of claim 1, wherein the first private key corresponds to a first public key.

15. The system of claim 14, wherein the first public key is associated with a smart contract.

16. The system of claim 1, wherein computing a cryptographic signature comprises computing the cryptographic signature via a decentralized application accessed via the first link.

17. The system of claim 1, wherein the first link initiates execution of a decentralized application.

18. The system of claim 1, further comprising validating the cryptographic signature of the first private key.

19. A method comprising:
receiving, from a first user, a contract initiation request;
generating, in response to the contract initiation request, a contract address;
providing the contract address to the first user;
receiving, from a second user, an activation of a first link corresponding to the contract address and generated by the first user, the first link comprising a first private key generated with respect to a first user;
receiving, from a third user, an activation of a second link generated by the second user and comprising a second private key, a cryptographic signature of the first private key, and one or more public keys; and
initiating an execution of the contract with respect to the third user.

20. The method of claim 19, wherein the cryptographic signature of the first private key comprises an aggregated cryptographic signature.

21. The method of claim 19, wherein the cryptographic signature of the first private key comprises a Schnorr signature.

22. The method of claim 19, wherein the second link further comprises one or more parameters.

23. The method of claim 22, wherein the one or more parameters comprise at least one of: one or more parameters that define one or more aspects of a subsequent dissemination of the second link, a contract address, an identifier associated with the second user, or a weight assigned by the second user.

24. The method of claim 19, wherein the contract initiation request further comprises one or more parameters associated with the contract.

25. The method of claim 19, wherein the contract initiation request further comprises a public key associated with the first user.

26. The method of claim 19, wherein the contract initiation request further comprises a bounty provided by the first user.

27. The method of claim 19, wherein the contract initiation request further comprises an address within a decentralized network and a cryptographic signature of the address, wherein the cryptographic signature of the address is generated using a secret inserted into the second link by the second user.

28. The method of claim 19, wherein the contract initiation request further comprises an address within a decentralized network.

29. The method of claim 19, wherein initiating an execution of the contract comprises validating one or more signatures within the second link.

30. A non-transitory computer readable medium having instructions stored thereon that, when executed by a processing device, cause the processing device to perform operations comprising:
receiving a first link, the first link comprising a first private key generated with respect to a first user;
generating, with respect to a second user, a second private key;
computing, using the second private key, a cryptographic signature of the first private key;
generating a second link comprising the second private key, the cryptographic signature of the first private key, and one or more public keys;
generating, with respect to a third user, a third private key;
computing, using the third private key, an aggregated cryptographic signature of the second private key; and
generating a third link comprising the third private key, the aggregated cryptographic signature of the second private key, and one or more public keys comprising a public key corresponding to the first private key and a public key corresponding to the second private key.
